(19) United States
(12) Patent Application Publication
(10) Pub. No.: US 2024/0283519 A1
(43) Pub. Date: Aug. 22, 2024

(54) NETWORK-CONTROLLED REPEATER BEHAVIOR FOLLOWING BEAM FAILURE RECOVERY

(71) Applicant: QUALCOMM Incorporated, San Diego, CA (US)

(72) Inventors: Navid ABEDINI, Basking Ridge, NJ (US); Tao LUO, San Diego, CA (US)

(21) Appl. No.: 18/503,293

(22) Filed: Nov. 7, 2023

Related U.S. Application Data
(60) Provisional application No. 63/485,841, filed on Feb. 17, 2023.

(51) Int. Cl. H04B 7/06; H04B 7/155

(52) U.S. Cl. CPC H04B 7/06964; H04B 7/15557

(57) ABSTRACT

Methods, systems, and devices for wireless communications are described. In some aspects, a wireless repeater, such as a network-controlled repeater (NCR), and a network entity may support one or more signaling- or configuration-based mechanisms according to which the wireless repeater is able to set a forwarding functionality of the wireless repeater to either an ON state or an OFF state based on a beam failure recovery (BFR) procedure. For example, upon recovery of communications between the wireless repeater and the network entity in accordance with the BFR procedure, the wireless repeater and the network entity may determine whether the forwarding functionality of the wireless repeater is to remain in an OFF state and, if so, for what time duration the forwarding functionality of the wireless repeater is to remain in the OFF state after the BFR procedure.

### CROSS REFERENCE

The present application for patent claims the benefit of U.S. Provisional Patent Application No. 63/485,841 by ABEDINI et al., entitled “NETWORK-CONTROLLED REPEATER BEHAVIOR FOLLOWING BEAM FAILURE RECOVERY,” filed Feb. 17, 2023, assigned to the assignee hereof, and expressly incorporated by reference herein.

### FIELD OF TECHNOLOGY

The following relates to wireless communications, including network-controlled repeater (NCR) behavior following beam failure recovery (BFR).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support network-controlled repeater (NCR) behavior following beam failure recovery (BFR). For example, the described techniques provide for one or more signaling- or configuration-based mechanisms according to which a wireless repeater is able to set a forwarding functionality of the wireless repeater to either an ON state or an OFF state based on a BFR procedure and according to which the wireless repeater and a network entity can maintain a mutual understanding regarding whether the forwarding functionality of the wireless repeater is set to the ON state or the OFF state.

A method for wireless communication at a wireless repeater is described. The method may include receiving, from a network entity at a mobile termination (MT) functionality of the wireless repeater, control signaling indicating at least one of a first configuration for directional communications between the wireless repeater and a user equipment (UE) or a second configuration for directional communications between the wireless repeater and the network entity, relaying, via a forwarding functionality of the wireless repeater, uplink communication from the UE to the network entity or downlink communication from the network entity to the UE, or both, in accordance with at least one of the first configuration for directional communications or the second configuration for directional communications, performing, at the MT functionality of the wireless repeater, a BFR procedure in accordance with a beam failure associated with the MT functionality of the wireless repeater, and setting the forwarding functionality of the wireless repeater to an ON state or an OFF state based on the BFR procedure.

An apparatus for wireless communication at a wireless repeater is described. The apparatus may include one or more processors, one or more memories coupled with the one or more processors, and instructions stored in the one or more memories. The instructions may be executable by the one or more processors to cause the apparatus to receive, from a network entity at a MT functionality of the wireless repeater, control signaling indicating at least one of a first configuration for directional communications between the wireless repeater and a UE or a second configuration for directional communications between the wireless repeater and the network entity, relay, via a forwarding functionality of the wireless repeater, uplink communication from the UE to the network entity or downlink communication from the network entity to the UE, or both, in accordance with at least one of the first configuration for directional communications or the second configuration for directional communications, perform, at the MT functionality of the wireless repeater, a BFR procedure in accordance with a beam failure associated with the MT functionality of the wireless repeater, and set the forwarding functionality of the wireless repeater to an ON state or an OFF state based on the BFR procedure.

Another apparatus for wireless communication at a wireless repeater is described. The apparatus may include means for receiving, from a network entity at a MT functionality of the wireless repeater, control signaling indicating at least one of a first configuration for directional communications between the wireless repeater and a UE or a second configuration for directional communications between the wireless repeater and the network entity, means for relaying, via a forwarding functionality of the wireless repeater, uplink communication from the UE to the network entity or downlink communication from the network entity to the UE, or both, in accordance with at least one of the first configuration for directional communications or the second configuration for directional communications, means for performing, at the MT functionality of the wireless repeater, a BFR procedure in accordance with a beam failure associated with the MT functionality of the wireless repeater, and means for setting the forwarding functionality of the wireless repeater to an ON state or an OFF state based on the BFR procedure.

A non-transitory computer-readable medium storing code for wireless communication at a wireless repeater is described. The code may include instructions executable by one or more processors to receive, from a network entity at a MT functionality of the wireless repeater, control signaling indicating at least one of a first configuration for directional communications between the wireless repeater and a UE or a second configuration for directional communications between the wireless repeater and the network entity, relay, via a forwarding functionality of the wireless repeater, uplink communication from the UE to the network entity or downlink communication from the network entity to the UE, or both, in accordance with at least one of the first configuration for directional communications or the second configuration for directional communications, perform, at the MT functionality of the wireless repeater, a BFR procedure in accordance with a beam failure associated with the MT functionality of the wireless repeater, and set the forwarding functionality of the wireless repeater to an ON state or an OFF state based on the BFR procedure.

In some examples of the method, apparatuses, and non-transitory computer-readable medium described herein, setting the forwarding functionality of the wireless repeater to the ON state or the OFF state may include operations, features, means, or instructions for setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both.

In some examples of the method, apparatuses, and non-transitory computer-readable medium described herein, setting the forwarding functionality of the wireless repeater to the ON state or the OFF state may include operations, features, means, or instructions for starting a timer in accordance with performing the BFR procedure, setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both, or an expiration of the timer.

Some examples of the method, apparatuses, and non-transitory computer-readable medium described herein may further include operations, features, means, or instructions for transmitting, to the network entity via the MT functionality of the wireless repeater, a recovery indication in accordance with the BFR procedure and receiving, from the network entity at the MT functionality of the wireless repeater, a response to the recovery indication in accordance with the BFR procedure, where the wireless repeater starts the timer based on receiving the response to the recovery indication.

Some examples of the method, apparatuses, and non-transitory computer-readable medium described herein may further include operations, features, means, or instructions for transmitting, to the network entity via the MT functionality of the wireless repeater, a recovery indication in accordance with the BFR procedure, where the wireless repeater starts the timer based on transmitting the recovery indication.

Some examples of the method, apparatuses, and non-transitory computer-readable medium described herein may further include operations, features, means, or instructions for receiving, from the network entity at the MT functionality of the wireless repeater, an indication of whether the wireless repeater may be to set the forwarding functionality of the wireless repeater to the ON state or the OFF state after the BFR procedure.

In some examples of the method, apparatuses, and non-transitory computer-readable medium described herein, receiving the indication from the network entity may include operations, features, means, or instructions for receiving the indication via a response to a recovery indication associated with the BFR procedure.

In some examples of the method, apparatuses, and non-transitory computer-readable medium described herein, receiving the indication from the network entity may include operations, features, means, or instructions for receiving the indication via separate signaling after a response to a recovery indication associated with the BFR procedure.

In some examples of the method, apparatuses, and non-transitory computer-readable medium described herein, the indication may be to set the forwarding functionality of the wireless repeater to the OFF state for a time period after the BFR procedure and the wireless repeater monitors for second control signaling indicating at least one of an updated first configuration for directional communications between the wireless repeater and the UE or an updated second configuration for directional communications between the wireless repeater and the network entity, or both, for a duration of the time period.

In some examples of the method, apparatuses, and non-transitory computer-readable medium described herein, setting the forwarding functionality of the wireless repeater to the ON state or the OFF state may include operations, features, means, or instructions for autonomously setting the forwarding functionality of the wireless repeater to the ON state or the OFF state based on a rule-based decision at the wireless repeater.

Some examples of the method, apparatuses, and non-transitory computer-readable medium described herein may further include operations, features, means, or instructions for measuring, as part of performing the BFR procedure, a set of reference signals associated with a set of directional beams, where a respective reference signal of the set of reference signals may be associated with a respective directional beam of the set of directional beams and setting the forwarding functionality of the wireless repeater to the ON state or the OFF state based on a set of measurements of the set of directional beams, where the rule-based decision at the wireless repeater may be associated with the set of measurements.

Some examples of the method, apparatuses, and non-transitory computer-readable medium described herein may further include operations, features, means, or instructions for identifying that one or more directional beams associated with the MT functionality of the wireless repeater may have signal strengths below a threshold signal strength in accordance with measuring the set of reference signals, where the wireless repeater sets the forwarding functionality of the wireless repeater to the OFF state in accordance with identifying that the one or more directional beams may have the signal strengths below the threshold signal strength.

Some examples of the method, apparatuses, and non-transitory computer-readable medium described herein may further include operations, features, means, or instructions for identifying a new directional beam for communications between the wireless repeater and the network entity in accordance with measuring the set of reference signals, where the wireless repeater sets the forwarding functionality of the wireless repeater to the OFF state in accordance with identifying the new directional beam for the communications between the wireless repeater and the network entity.

Some examples of the method, apparatuses, and non-transitory computer-readable medium described herein may further include operations, features, means, or instructions for identifying a same directional beam for communications between the wireless repeater and the network entity as was previously associated with the MT functionality of the wireless repeater in accordance with measuring the set of reference signals, where the wireless repeater sets the forwarding functionality of the wireless repeater to the ON state in accordance with identifying the same directional beam.

In some examples of the method, apparatuses, and non-transitory computer-readable medium described herein, identifying, based on measuring the set of reference signals, a first set of one or more directional beams of the set of directional beams that may have signal strengths above a threshold signal strength and setting the forwarding functionality of the wireless repeater to the ON state or the OFF state based on a comparison between the first set of one or more directional beams and a second set of one or more directional beams associated with the first configuration for directional communications or the second configuration for directional communications, or both.

In some examples of the method, apparatuses, and non-transitory computer-readable medium described herein, setting the forwarding functionality of the wireless repeater to the ON state or the OFF state may include operations, features, means, or instructions for setting the forwarding functionality of the wireless repeater to the ON state based on the first set of one or more directional beams including an entirety of the second set of one or more directional beams and setting the forwarding functionality of the wireless repeater to the OFF state based on the first set of one or more directional beams failing to include the entirety of the second set of one or more directional beams.

In some examples of the method, apparatuses, and non-transitory computer-readable medium described herein, the first set of one or more directional beams includes a subset of the second set of one or more directional beams and the wireless repeater sets the forwarding functionality of the wireless repeater to the ON state with respect to the subset of the second set of one or more directional beams and sets the forwarding functionality of the wireless repeater to the OFF state with respect to a remainder of the second set of one or more directional beams.

Some examples of the method, apparatuses, and non-transitory computer-readable medium described herein may further include operations, features, means, or instructions for transmitting, to the network entity via the MT functionality of the wireless repeater, an indication of a decision at the wireless repeater to set the forwarding functionality of the wireless repeater to the ON state or the OFF state.

Some examples of the method, apparatuses, and non-transitory computer-readable medium described herein may further include operations, features, means, or instructions for transmitting, to the network entity via the MT functionality of the wireless repeater, a request for confirmation by the network entity of the decision at the wireless repeater to set the forwarding functionality of the wireless repeater to the ON state or the OFF state.

Some examples of the method, apparatuses, and non-transitory computer-readable medium described herein may further include operations, features, means, or instructions for transmitting, to the network entity via the MT functionality of the wireless repeater, a request for second control signaling indicating at least one of an updated first configuration for directional communications between the wireless repeater and the UE or an updated second configuration for directional communications between the wireless repeater and the network entity, or both.

Some examples of the method, apparatuses, and non-transitory computer-readable medium described herein may further include operations, features, means, or instructions for receiving, from the network entity at the MT functionality of the wireless repeater, second control signaling indicating at least one of an updated first configuration for directional communications between the wireless repeater and the UE or an updated second configuration for directional communications between the wireless repeater and the network entity, or both, based on the BFR procedure, setting the forwarding functionality of the wireless repeater to the ON state in accordance with receiving the second control signaling, and relaying, via the forwarding functionality of the wireless repeater, second uplink communication from the UE to the network entity or second downlink communication from the network entity to the UE, or both, in accordance with at least one of the updated first configuration for directional communications and the updated second configuration for directional communications.

Some examples of the method, apparatuses, and non-transitory computer-readable medium described herein may further include operations, features, means, or instructions for transmitting, to the network entity via the MT functionality of the wireless repeater, an indication of a capability of the wireless repeater associated with setting the forwarding functionality of the wireless repeater to the ON state or the OFF state based on the BFR procedure.

In some examples of the method, apparatuses, and non-transitory computer-readable medium described herein, the capability may be indicative of a specific one or more mechanisms, from a set of mechanisms, according to which the wireless repeater may be able to determine whether to set the forwarding functionality of the wireless repeater to the ON state or the OFF state based on the BFR procedure.

Some examples of the method, apparatuses, and non-transitory computer-readable medium described herein may further include operations, features, means, or instructions for setting the forwarding functionality of the wireless repeater to the ON state may be associated with a continued use of at least one of the first configuration for directional communications between the wireless repeater and the UE or the second configuration for directional communications between the wireless repeater and the network entity after the BFR procedure and the wireless repeater continues to relay communications between the UE and the network entity if the forwarding functionality of the wireless repeater may be set to the ON state.

Some examples of the method, apparatuses, and non-transitory computer-readable medium described herein may further include operations, features, means, or instructions for setting the forwarding functionality of the wireless repeater to the OFF state may be associated with a waiting for second control signaling indicating at least one of an updated first configuration for directional communications between the wireless repeater and the UE or an updated second configuration for directional communications between the wireless repeater and the network entity, or both and the wireless repeater refrains from relaying communications between the UE and the network entity if the forwarding functionality of the wireless repeater may be set to the OFF state.

A method for wireless communication at a network entity is described. The method may include outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity, participating in uplink communication from the UE to the network entity via the forwarding functionality of the wireless repeater or downlink communication from the network entity to the UE via the forwarding functionality of the wireless repeater, or both, performing a BFR procedure in accordance with a beam failure associated with the MT functionality of the wireless repeater, and communicating with the wireless repeater in accordance with a setting of the forwarding functionality of the wireless repeater to an ON state or an OFF state based on the BFR procedure.

An apparatus for wireless communication at a network entity is described. The apparatus may include one or more processors, one or more memories coupled with the one or more processors, and instructions stored in the one or more memories. The instructions may be executable by the one or more processors to cause the apparatus to output, to a MT functionality of a wireless repeater for use at a forwarding functionality of the wireless repeater, control signal indicating at least one of a first configuration for directional communications between the wireless repeater and a UE or a second configuration for directional communications between the wireless repeater and the network entity, participate in uplink communication from the UE to the network entity via the forwarding functionality of the wireless repeater or downlink communication from the network entity to the UE via the forwarding functionality of the wireless repeater, or both, perform a BFR procedure in accordance with a beam failure associated with the MT functionality of the wireless repeater, and communicate with the wireless repeater in accordance with a setting of the forwarding functionality of the wireless repeater to an ON state or an OFF state based on the BFR procedure.

Another apparatus for wireless communication at a network entity is described. The apparatus may include means for outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity, means for participating in uplink communication from the UE to the network entity via the forwarding functionality of the wireless repeater or downlink communication from the network entity to the UE via the forwarding functionality of the wireless repeater, or both, means for performing a BFR procedure in accordance with a beam failure associated with the MT functionality of the wireless repeater, and means for communicating with the wireless repeater in accordance with a setting of the forwarding functionality of the wireless repeater to an ON state or an OFF state based on the BFR procedure.

A non-transitory computer-readable medium storing code for wireless communication at a network entity is described. The code may include instructions executable by one or more processors to output, to a MT functionality of a wireless repeater for use at a forwarding functionality of the wireless repeater, control signal indicating at least one of a first configuration for directional communications between the wireless repeater and a UE or a second configuration for directional communications between the wireless repeater and the network entity, participate in uplink communication from the UE to the network entity via the forwarding functionality of the wireless repeater or downlink communication from the network entity to the UE via the forwarding functionality of the wireless repeater, or both, perform a BFR procedure in accordance with a beam failure associated with the MT functionality of the wireless repeater, and communicate with the wireless repeater in accordance with a setting of the forwarding functionality of the wireless repeater to an ON state or an OFF state based on the BFR procedure.

Some examples of the method, apparatuses, and non-transitory computer-readable medium described herein may further include operations, features, means, or instructions for starting a timer in accordance with performing the BFR procedure, expecting the forwarding functionality of the wireless repeater to be set to the OFF state until the network entity transmits second control signaling indicating at least one of an updated first configuration for directional communications between the wireless repeater and the UE or an updated second configuration for directional communications between the wireless repeater and the network entity, or both, or an expiration of the timer.

Some examples of the method, apparatuses, and non-transitory computer-readable medium described herein may further include operations, features, means, or instructions for obtaining, from the MT functionality of the wireless repeater, a recovery indication in accordance with the BFR procedure and outputting, to the MT functionality of the wireless repeater, a response to the recovery indication in accordance with the BFR procedure, where the network entity starts the timer based on transmitting the response to the recovery indication.

Some examples of the method, apparatuses, and non-transitory computer-readable medium described herein may further include operations, features, means, or instructions for obtaining, from the MT functionality of the wireless repeater, a recovery indication in accordance with the BFR procedure, where the network entity starts the timer based on receiving the recovery indication.

In some examples of the method, apparatuses, and non-transitory computer-readable medium described herein, outputting, to the MT functionality of the wireless repeater, an indication of whether the wireless repeater may be to set the forwarding functionality of the wireless repeater to the ON state or the OFF state after the BFR procedure.

In some examples of the method, apparatuses, and non-transitory computer-readable medium described herein, transmitting the indication to the wireless repeater may include operations, features, means, or instructions for outputting the indication via a response to a recovery indication associated with the BFR procedure.

In some examples of the method, apparatuses, and non-transitory computer-readable medium described herein, transmitting the indication to the wireless repeater may include operations, features, means, or instructions for outputting the indication via separate signaling after a response to a recovery indication associated with the BFR procedure.

In some examples of the method, apparatuses, and non-transitory computer-readable medium described herein, the indication may be to set the forwarding functionality of the wireless repeater to the OFF state for a time period after the BFR procedure and the network entity selectively transmits second control signaling indicating at least one of an updated first configuration for directional communications between the wireless repeater and the UE or an updated second configuration for directional communications between the wireless repeater and the network entity, or both, during the time period.

Some examples of the method, apparatuses, and non-transitory computer-readable medium described herein may further include operations, features, means, or instructions for obtaining, from the MT functionality of the wireless repeater, an indication of a decision at the wireless repeater to set the forwarding functionality of the wireless repeater to the ON state or the OFF state.

Some examples of the method, apparatuses, and non-transitory computer-readable medium described herein may further include operations, features, means, or instructions for obtaining, from the MT functionality of the wireless repeater, a request for confirmation by the network entity of the decision at the wireless repeater to set the forwarding functionality of the wireless repeater to the ON state or the OFF state.

Some examples of the method, apparatuses, and non-transitory computer-readable medium described herein may further include operations, features, means, or instructions for obtaining, from the MT functionality of the wireless repeater, a request for second control signaling indicating at least one of an updated first configuration for directional communications between the wireless repeater and the UE or an updated second configuration for directional communications between the wireless repeater and the network entity, or both.

Some examples of the method, apparatuses, and non-transitory computer-readable medium described herein may further include operations, features, means, or instructions for obtaining, from the MT functionality of the wireless repeater, an indication of a capability of the wireless repeater associated with setting the forwarding functionality of the wireless repeater to the ON state or the OFF state based on the BFR procedure.

In some examples of the method, apparatuses, and non-transitory computer-readable medium described herein, the setting of the forwarding functionality of the wireless repeater to the ON state may be associated with a continued use of at least one of the first configuration for directional communications between the wireless repeater and the UE or the second configuration for directional communications between the wireless repeater and the network entity after the BFR procedure and the wireless repeater continues to relay communications between the UE and the network entity if the forwarding functionality of the wireless repeater may be set to the ON state.

In some examples of the method, apparatuses, and non-transitory computer-readable medium described herein, the setting of the forwarding functionality of the wireless repeater to the OFF state may be associated with a selective transmission of second control signaling indicating at least one of an updated first configuration for directional communications between the wireless repeater and the UE or an updated second configuration for directional communications between the wireless repeater and the network entity, or both and the wireless repeater refrains from relaying communications between the UE and the network entity if the forwarding functionality of the wireless repeater may be set to the OFF state.

### BRIEF DESCRIPTION OF THE DRAWINGS

FIG. 1 illustrates an example of a wireless communications system that supports network-controlled repeater (NCR) behavior following beam failure recovery (BFR) in accordance with one or more aspects of the present disclosure.

FIG. 2 illustrates an example of a signaling diagram that supports NCR behavior following BFR in accordance with one or more aspects of the present disclosure.

FIG. 3 illustrates an example of a process flow that supports NCR behavior following BFR in accordance with one or more aspects of the present disclosure.

FIGS. 4 and 5 illustrate block diagrams of devices that support NCR behavior following BFR in accordance with one or more aspects of the present disclosure.

FIG. 6 illustrates a block diagram of a communications manager that supports NCR behavior following BFR in accordance with one or more aspects of the present disclosure.

FIG. 7 illustrates a diagram of a system including a device that supports NCR behavior following BFR in accordance with one or more aspects of the present disclosure.

FIGS. 8 and 9 illustrate block diagrams of devices that support NCR behavior following BFR in accordance with one or more aspects of the present disclosure.

FIG. 10 illustrates a block diagram of a communications manager that supports NCR behavior following BFR in accordance with one or more aspects of the present disclosure.

FIG. 11 illustrates a diagram of a system including a device that supports NCR behavior following BFR in accordance with one or more aspects of the present disclosure.

FIGS. 12 and 13 illustrate flowcharts showing methods that support NCR behavior following BFR in accordance with one or more aspects of the present disclosure.

### DETAILED DESCRIPTION

In some deployments, various devices may communicate with each other via another device, such as a wireless repeater. In such deployments, a wireless repeater may amplify and forward (e.g., transmit) radio frequency (RF) signaling between two devices (without decoding the RF signaling). For example, a wireless repeater may amplify and forward uplink communications from a user equipment (UE) to a network entity or may amplify and forward downlink communications from the network entity to the UE, or both. A wireless repeater may receive and forward signaling directionally (e.g., using one or more directional beams) and, in some aspects, a network entity may control which directional beams a wireless repeater uses for receiving and forwarding signaling. For example, a wireless repeater, such as a network-controlled repeater (NCR), may receive control information (e.g., via control signaling) from a network entity indicating how the wireless repeater is to directionally receive and forward signaling between the network entity and another device (e.g., a UE). In such examples, the wireless repeater may receive the control information via a mobile termination (MT) functionality of the wireless repeater (e.g., an NCR-MT entity or component) and may use the control information to configure a forwarding functionality of the wireless repeater (e.g., an NCR-FWD entity or component).

In some scenarios, however, a wireless repeater may experience a beam failure and may perform or otherwise participate in a beam failure recovery (BFR) procedure. In such scenarios, the wireless repeater and a network entity may exchange signaling to recover from the beam failure and, if successful, the wireless repeater and the network entity 105 may identify a directional beam to use for subsequent directional communications without declaring a radio link failure (RLF). If the BFR procedure is successful, a reconfiguration (e.g., a Radio Resource Control (RRC) reconfiguration, such as a reconfiguration via RRC signaling) of the directional beams used by the wireless repeater for forwarding signaling may optionally occur. Due to such a lack of definiteness associated with whether a reconfiguration of the directional beams used by the wireless repeater is performed, the wireless repeater (among other communicating devices) may experience ambiguity regarding whether the wireless repeater is to continue or stop amplifying and forwarding signaling after a successful BFR procedure. Such ambiguity may lead to mis-informed scheduling or transmission attempts, which may result in relatively higher communication failures, greater system interference, and poorer spectral efficiency.

In some implementations, a wireless repeater (e.g., an NCR) and a network entity may support one or more signaling- or configuration-based mechanisms according to which the wireless repeater is able to set a forwarding functionality of the wireless repeater to either an ON state or an OFF state based on a BFR procedure and according to which the wireless repeater and the network entity can maintain a mutual understanding regarding whether the forwarding functionality of the wireless repeater is set to the ON state or the OFF state. As described herein, an ON state (which may be referred to as an active state) for the forwarding functionality of the wireless repeater may be associated with or involve an active use of the forwarding functionality to amplify and forward signaling as configured, indicated, or otherwise scheduled. An OFF state (which may be referred to as an inactive state) for the forwarding functionality of the wireless repeater may be associated with or involve a deactivation of the forward functionality, such that the forwarding functionality does not amplify and forward signaling (regardless of what signaling is configured, indicated, or otherwise scheduled).

In accordance with the one or more signaling- or configuration-based mechanisms, the forwarding functionality of the wireless repeater may remain in an OFF state after a BFR procedure until the wireless repeater receives a reconfiguration of one or more directional beams used by the wireless repeater. Additionally, or alternatively, the wireless repeater (e.g., an MT functionality of the wireless repeater) may start a timer at some point during or after the BFR procedure and the forwarding functionality of the wireless repeater may remain in an OFF state until either the wireless repeater receives control signaling (e.g., a reconfiguration of the directional beams or new side control information) or the timer expires, at which point the forwarding functionality may switch to an ON state. Additionally, or alternatively, the network entity may transmit an explicit indication to the wireless repeater (e.g., the MT functionality of the wireless repeater) to indicate whether the forwarding functionality is to remain in an OFF state or switch to an ON state after the BFR procedure. Additionally, or alternatively, the wireless repeater may support one or more rules according to which the wireless repeater (e.g., the MT functionality of the wireless repeater) may autonomously determine or select whether to set the forwarding functionality to an OFF state or an ON state after the BFR procedure.

Particular implementations of the subject matter described in this disclosure can be implemented to realize one or more of the following potential advantages. For example, as a result of supporting the one or more signaling- or configuration-based mechanisms according to which the wireless repeater is able to set a forwarding functionality of the wireless repeater to either an ON state or an OFF state based on a BFR procedure, the wireless repeater and other communicating devices may reduce ambiguity and achieve greater synchronization. Further, as a result of facilitating less ambiguity and greater synchronization following a BFR procedure, wireless repeaters may be available more often or may experience greater adoption, which may increase coverage (e.g., extend a communication range between two or more devices). Accordingly, devices using a wireless repeater may achieve or experience greater system capacity, higher data rates, and greater spectral efficiency. Moreover, by establishing mechanisms according to which the wireless repeater is able to determine whether to turn forwarding on or off based on a BFR procedure, a system may reduce or avoid interference that might otherwise be caused by a mis-aligned repeater (e.g., a repeater using incorrect or unsuitable directional beams to amplify and forward signaling) as well as improve power savings at the wireless repeater.

Aspects of the disclosure are initially described in the context of wireless communications systems. Aspects of the disclosure are additionally illustrated by and described with reference to a signaling diagram and a process flow. Aspects of the disclosure are further illustrated by and described with reference to apparatus diagrams, system diagrams, and flowcharts that relate to network-controlled repeater behavior following beam failure recovery.

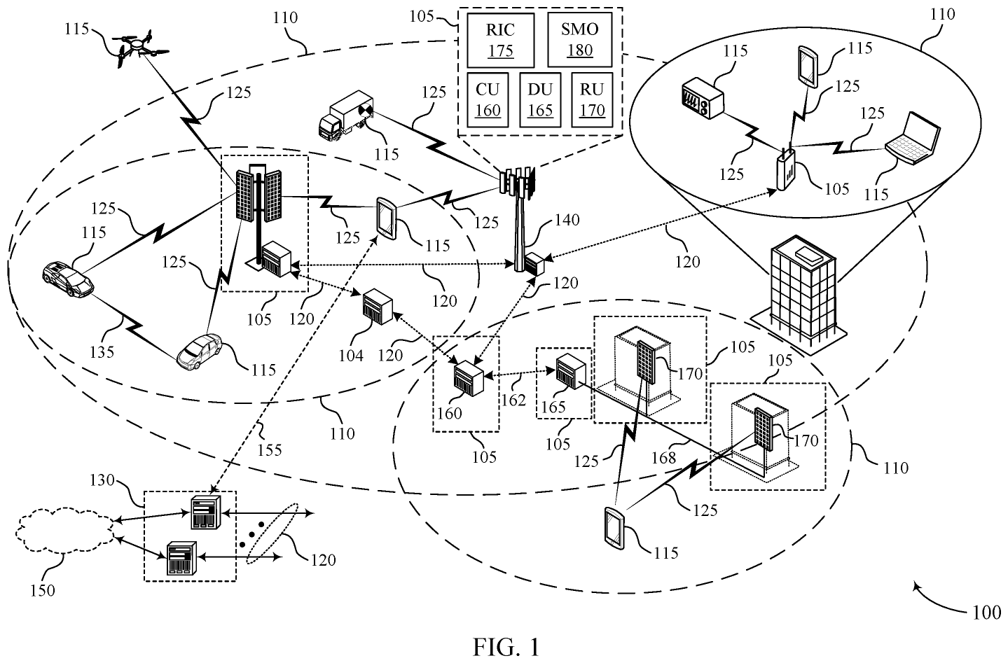

FIG. 1 illustrates an example of a wireless communications system 100 that supports network-controlled repeater behavior following beam failure recovery in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support network-controlled repeater behavior following beam failure recovery as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, the wireless communications system 100 may support one or more beam management techniques. For example, a device may be in an RRC idle state (e.g., RRC_IDLE) or an RRC inactive state (e.g., RRC_INACTIVE) and may transmit or receive one or more tracking reference signals (TRSs) prior to initial access. As part of initial access, one or more devices (e.g., a UE 115, a network entity 105, a wireless repeater, etc.) may perform synchronization signal block (SSB) beam sweeping, which may be associated with wide beam sweeping. In some aspects, initial access may involve a contention based random access (CBRA) procedure associated with transmission or reception of random access channel (RACH) occasions (ROs) or preambles or transmission or reception of SSBs or a contention free random access (CFRA) procedure.

Upon establishment of a beam pair between two devices (e.g., between a UE 115 and a network entity 105, between a network entity 105 and a wireless repeater, between a wireless repeater and a UE 115, etc.), each device may perform beam management in an RRC connected state (e.g., RRC_CONNECTED). In some aspects, such beam management may include transmission or reception of one or more SSBs, one or more CSI reference signals (CSI-RSs), or one or more sounding reference signals (SRSs), Layer 1 (L1) reference signal receive power (RSRP) reporting, and transmission configuration indicator (TCI) state configuration or indication. In some aspects, beam management (e.g., SSB or CSI-RS associated beam management) may be associated with a set of processes P1, P2, and P3 that are designed for beam management while a device is in a connected state. P1 may be associated with beam selection, P2 may be associated with beam refinement for the transmitter, and P3 may be associated with beam refinement for the receiver. In some aspects, beam management may be associated with a set of different uplink beam management procedures U1, U2, and U3, where each beam management procedure may be associated with a beam sweep.

Additionally, or alternatively, beam management may include L1 signal-to-interference-plus-noise ratio (SINR) reporting and overhead and latency reduction. In some aspects, overhead and latency reduction may be associated with or otherwise involve one or more component carrier (CC) group beam updates and lower latency uplink beam updates. Further, in some aspects, beam management may involve beam measurement or reporting, or both with association to unified TCI states and L1 or Layer 2 (L2) centric mobility. For example, beam management procedures may include dynamic TCI state updates, uplink multi-panel selection, maximum permissible exposure (MPE) mitigation, or other techniques that facilitate further beam management latency reduction. Further, some beam management procedures may include procedures associated high speed train (HST) deployments, single frequency network (SFN) deployments, or multi-TRP deployments, or any combination thereof.

In some aspects, a device may measure, identify, or otherwise experience a beam failure detection (BFD) based on measurements associated with beam management and may perform one or more beam failure recovery BFR procedures. BFD and BFR may be performed for a primary cell (PCell), a primary secondary cell (PSCell), or a secondary cell (SCell). Further, BFD and BFR may involve transmission or reception of one or more BFD reference signals (BFD-RSs), a physical downlink control channel (PDCCH) block error rate (BLER) measurement, a link recovery indication (e.g., a link recovery request) via a random access message (if for PCell), a link recovery indication (e.g., a link recovery request) via a scheduling request (SR) (if for SCell), or a MAC control element (MAC-CE)-based BFR for SCell, or any combination thereof. In some cases, such as in cases in which a device is unable to recover a failed beam pair link during a BFR procedure, the device may declare a radio link failure (RLF) and attempt to re-establish a connection via one or more initial establishment procedures. For example, if a device declares RLF, an RRC reconfiguration may occur to re-establish an RRC connection between the device and another device (e.g., a network entity 105).

In some implementations, a wireless repeater (e.g., an NCR) and a network entity 105 may support one or more signaling- or configuration-based mechanisms according to which the wireless repeater is able to set a forwarding functionality of the wireless repeater to either an ON state or an OFF state based on a (successful) BFR procedure and according to which the wireless repeater and the network entity 105 can maintain a mutual understanding regarding whether the forwarding functionality of the wireless repeater is set to the ON state or the OFF state. As described herein, an ON or active state for the forwarding functionality of the wireless repeater may be associated with or involve an active use of the forwarding functionality to amplify and forward signaling as configure, indicated, or otherwise scheduled. Thus, even when the forwarding functionality of the wireless repeater is described as being in an ON or active state, there may be time periods (e.g., slots) during which the forwarding functionality is off (e.g., including slots when uplink or downlink communication is not configured, indicated, or otherwise scheduled). As such, the wireless repeater may reduce interference and save power. An OFF or inactive state for the forwarding functionality of the wireless repeater may be associated with or involve a deactivation of the forward functionality, such that the forwarding functionality does not amplify and forward signaling (regardless of what signaling is configured, indicated, or otherwise scheduled).

In accordance with the one or more signaling- or configuration-based mechanisms, the forwarding functionality of the wireless repeater may remain in an OFF state after a BFR procedure until the wireless repeater receives (e.g., from the network entity 105) a reconfiguration of the directional beams used by the wireless repeater. Additionally, or alternatively, the wireless repeater (e.g., an MT functionality of the wireless repeater) may start a timer at some point during or after the BFR procedure and the forwarding functionality of the wireless repeater may remain in an OFF state until either the wireless repeater receives control signaling (e.g., a reconfiguration of the directional beams or new side control information) or the timer expires, at which point the forwarding functionality may switch to an ON state. Additionally, or alternatively, the network entity 105 may transmit an explicit indication to the wireless repeater (e.g., the MT functionality of the wireless repeater) to indicate whether the forwarding functionality is to remain in an OFF state or switch to an ON state after the BFR procedure. Additionally, or alternatively, the wireless repeater may support one or more rules according to which the wireless repeater (e.g., the MT functionality of the wireless repeater) may autonomously determine or select whether to set the forwarding functionality to an OFF state or an ON state.

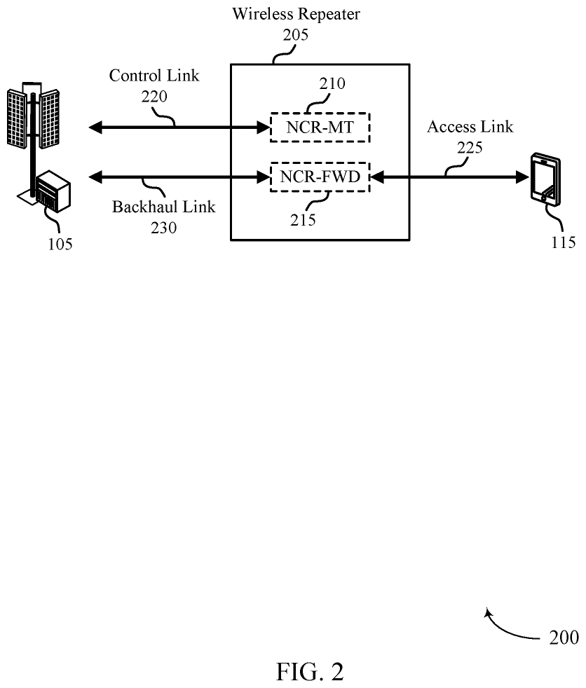

FIG. 2 illustrates an example of a signaling diagram 200 that supports network-controlled repeater behavior following beam failure recovery in accordance with one or more aspects of the present disclosure. The signaling diagram 200 may implement or be implemented to realize aspects of the wireless communications system 100. For example, the signaling diagram 200 illustrates communication between a UE 115, a network entity 105, and a wireless repeater 205, which may be examples of corresponding devices illustrated and described herein, including by and with reference to FIG. 1.

The wireless repeater 205 (e.g., an NCR) may include or be associated with multiple (e.g., two) components (e.g., functionalities), including an MT functionality 210 and a forwarding functionality 215. As illustrated in the example of the signaling diagram 200, the MT functionality 210 may equivalently be understood or referred to as an NCR-MT entity or component, and the forwarding functionality 215 may equivalently be understood or referred to as an NCR-FWD entity or component.

The MT functionality 210 may be defined as or may be an example of a function entity to communicate with the network entity 105 via a control link 220 (which may be understood or referred to as a C-link) to enable information exchanges between the wireless repeater 205 and the network entity 105. Such information exchanges may include side control information exchanges, where side control information may be at least for the control of the forwarding functionality 215 of the wireless repeater 205. In some aspects, the control link 220 may be based on or otherwise associated with an NR Uu interface.

The forwarding functionality 215 may be defined as or may be an example of a function entity to perform amplifying and forwarding of uplink or downlink RF signaling between the network entity 105 and the UE 115 via an access link 225 and a backhaul link 230. In some aspects, the network entity 105 may control a behavior (e.g., a functioning or operation) of the forwarding functionality 215 via the side control information. In other words, the MT functionality 210 may control a behavior of the forwarding functionality 215 according to the received side control information from the network entity 105.

Side control information may carry beamforming information for the access link 225 of the forwarding functionality 215, beamforming information for the backhaul link 230 of the forwarding functionality 215, or an ON-OFF indication for the forwarding functionality 215. Regarding the beamforming information for the access link 225 of the forwarding functionality 215, an aperiodic indication may be supported via downlink control information (DCI) and a periodic indication may be supported via RRC signaling. In other words, the network entity 105 may transmit a DCI message to the MT functionality 210 of the wireless repeater 205 to indicate aperiodic beamforming information for the access link 225 or may transmit RRC signaling to indicate periodic beamforming information for the access link 225.

Regarding the beamforming information for the backhaul link 230 of the forwarding functionality 215, an explicit indication may be supported where one of the beams of the MT functionality 210 can be indicated semi-statically (e.g., via a MAC-CE) to be used for the forwarding functionality 215. In an absence of an explicit indication, the wireless repeater 205 may support one or more rules for the wireless repeater 205 to choose (e.g., select, identify, determine, ascertain, etc.) a beam for the backhaul link 230 given (e.g., based on) the beam(s) and configurations of the MT functionality 210. In some aspects, the wireless repeater 205 may use a same beam for the backhaul link 230 as the wireless repeater 205 uses for the control link 220. In some other aspects, the wireless repeater 205 may use a different beam for the backhaul link 230 than the wireless repeater 205 uses for the control link 220 (which may be indicated via a MAC-CE or DCI). Either way, the beams available (e.g., trained) for use for the control link 220 may include beams that are available for use for the backhaul link 230. In other words, the beams available for the backhaul link 230 may be a subset of the beams available for the control link 220.

Regarding the ON-OFF indication, such an ON-OFF indication may be implicitly supported via an access link beam indication. In other words, if the side control information indicates a beam for the access link 225, the wireless repeater 205 may interpret such an indication as an ON indication for the forwarding functionality 215. Alternatively, if the side control information does not indicate a beam for the access link 225, the wireless repeater 205 may interpret such a lack of an indication as an OFF indication for the forwarding functionality 215. Accordingly, the forwarding functionality 215 may actively amplify and forward signaling in accordance with a union of slots or symbols during which aperiodic, periodic, or semi-static communication is configured or scheduled between the UE 115 and the network entity 105 and may refrain from amplifying and forwarding signaling otherwise.

The network entity 105 and the wireless repeater 205 may support various aspects related to beamforming indications (which may be provided via control signaling, including RRC signaling, a MAC-CE, DCI, or any combination thereof). In some aspects, for example, for each periodic beam indication for the access link 225, RRC signaling (e.g., one RRC signaling or one RRC information element) may be used with the information defined by or including a list of X (1≤X≤Xₘₐₓ) forwarding resources, each forwarding resource being defined as {beam index, time resource}, such as defined by a {beam index, time resource} pair. Each time resource may be defined by a {Starting slot defined as the slot offset in one period, starting symbol defined by symbol offset within the slot, duration defined by the number of symbols} with one or more dedicated fields. In some aspects, a periodicity may be configured as part of the RRC signaling for periodic beam indication, where a same periodicity may be assumed for a set of (e.g., for all) time resource(s) in one periodic beam indication. In some aspects, a reference subcarrier spacing (SCS) may be configured as part of the RRC signaling for periodic beam indication, where a same reference SCS may be assumed for a set of (e.g., for all) time resource(s) in one periodic beam indication.

Additionally, or alternatively, for each aperiodic beam indication for the access link 225, DCI (e.g., one DCI) may be used with the information defined by or including a set of up to Lₘₐₓ fields and a set of up to Tₘₐₓ fields. In some aspects, the up to Lₘₐₓ fields may be used to indicate the beam information and each field may refer to one beam index, where a bitwidth of this field may be determined (e.g., identified, calculated, selected, ascertained, etc.) by a quantity of beams used for the access link 225. In some aspects, the up to Tₘₐₓ fields may each indicate a time resource, where a list of time resource(s) may be pre-defined (e.g., pre-configured or pre-loaded at a device) by RRC signaling, and where a bitwidth of this field for time resource indication may be associated with or determined (e.g., identified, calculated, selected, ascertained, etc.) by a length of the list. A value of Tₘₐₓ may be down selected between Tₘₐₓ=1 or Tₘₐₓ=Lₘₐₓ. The network entity 105 and the wireless repeater 205 may support various associations between time indication and beam indication. In some aspects, each time resource may be defined by a {Starting slot defined as the slot offset, starting symbol defined by symbol offset within the slot, duration defined by the number of symbols} with one or more dedicated fields.

Additionally, or alternatively, a semi-static beam indication for the backhaul link 230 may be supported in accordance with one or more beam indication frameworks. For example, if a first beam indication framework is used for the MT functionality 210, a downlink beam may be indicated by MAC-CE (e.g., from the network entity 105) to select one TCI state ID from an RRC-configured list of beams for the control link 220 and an uplink beam may be indicated by an SRS resource indicator (SRI) on the control link 220 via a MAC-CE. For further example, if a second beam indication framework is used for the MT functionality 210, a downlink beam and an uplink beam may be indicated by MAC-CE to select one TCI state ID from an RRC-configured list of beams for the control link 220.

In some aspects, the wireless repeater 205 may support various behaviors (e.g., operations or functions) depending on a state (e.g., an RRC state or mode) of the MT functionality 210. For example, when the MT functionality 210 is in an RRC_CONNECTED mode, the forwarding functionality 215 may be in an ON or OFF state following the side control information received from the network entity 105. When the MT functionality 210 enters an RRC_INACTIVE mode, the forwarding functionality 215 may be in an ON or OFF state following a last (e.g., most recent) configuration received from the network entity 105. The wireless repeater 205 may support various behaviors when released to an RRC_IDLE mode. Further, if an RLF is declared by the MT functionality 210, the MT functionality 210 may perform cell selection and trigger an RRC re-establishment procedure. During an RRC re-establishment procedure, the forwarding functionality 215 may be in an OFF state (e.g., may be set to an OFF state). If the MT functionality 210 enters an RRC_IDLE mode due to an inability to find a suitable cell, the forwarding functionality 215 may switch to (e.g., be set to) an OFF state.

In some systems, however, devices may lack mutually understood rules or mechanisms associated with a behavior of the forwarding functionality 215 when a BFR occurs or happens in the control link 220 (e.g., the C-link). In other words, such systems may lack a configured or mutually known rule or mechanism to address or specify a behavior of the forwarding functionality 215 when the MT functionality 210 goes to BFR and after a successful BFR procedure. In some implementations, the forwarding functionality 215 may be in an OFF state (and not following any previously indicated side control or configuration information) while the MT functionality 210 declares beam failure and performs a BFR procedure (e.g., while the MT functionality 210 is in the process of recovery).

Unlike RLF, after which the MT functionality 210 may re-establish an RRC connection and receive new RRC configurations associated with access link beamforming indication and TCI states for the MT functionality 210, there may be no RRC re-establishment (e.g., no automatic RRC reconfiguration, as is the case for RLF) in case of a successful BFR procedure, where a successful BFR procedure may be understood as a BFR procedure that results in an identification of a suitable beam (or beam pair) between two communicating devices without declaring RLF. In other words, some configurations (such as beams associated with the MT functionality 210 or the access link beamforming for the forwarding functionality 215, or both) may not be updated (e.g., via configuration signaling) after the BFR procedure. In some cases, however, even when a BFR procedure is successful, it may be desirable or relatively more suitable to reconfigure some beamforming information at the wireless repeater 205 (either at the MT functionality 210 or the forwarding functionality 215, or at both). As such, RRC reconfiguration might be performed in some BFR scenarios while RRC reconfiguration is not performed in some other BFR scenarios.

Accordingly, in some implementations, the wireless repeater 205 and the network entity 105 may support one or more signaling- or configuration-based mechanisms according to which the wireless repeater 205 and the network entity 105 may maintain synchronization relating to when or if the forwarding functionality 215 is expected to become active and follow any previously received configurations (e.g., a periodic access link beamforming configuration to periodically transmit or receive on a set of preconfigured resources). As such, in examples in which the wireless repeater 205 and the network entity 105 change some configurations (such that there is an RRC reconfiguration), the forwarding functionality 215 may remain in an OFF state until the time when the MT functionality 210 receives a new or updated RRC configuration from the network entity 105. Alternatively, in examples in which the wireless repeater 205 and the network entity 105 do not change a configuration (such that there may not be any RRC reconfiguration), the forwarding functionality 215 may be set to an ON state and follow a previous configuration. In other words, the wireless repeater 205 and the network entity 105 may support one or more mechanisms to address both of such examples (BFR involving an RRC reconfiguration and BFR excluding an RRC reconfiguration) and to inform the wireless repeater 205 and the network entity 105 of whether the forwarding functionality 215 is expected to wait (and how long the forwarding functionality 215 is expected to wait) for an RRC configuration.

In some implementations, after a BFR procedure, the forwarding functionality 215 may remain in an OFF or inactive state (e.g., as a default) until the wireless repeater 205 receives a new RRC reconfiguration (e.g., associated with side control information for the wireless repeater 205). Alternatively, in some other implementations, the forwarding functionality 215 may switch to an ON or active state (e.g., as a default) after the BFR procedure (e.g., immediately after the BFR procedure). The wireless repeater 205 may indicate which behavior the forwarding functionality 215 may have to the network entity 105 (e.g., may indicate that the forwarding functionality 215 remains in an OFF or inactive state after BFR as a default or that the forwarding functionality 215 switches to an ON or active state after BFR as a default).

Additionally, or alternatively, the wireless repeater 205 may support or define a timer and, after BFR, the forwarding functionality 215 may remain in an OFF or inactive (e.g., sleep) state until either the wireless repeater 205 receives an RRC reconfiguration and/or a new side control information (e.g., via MAC-CE or DCI) or upon expiry of the timer. In some examples, the wireless repeater 205 may start the timer after receiving a response (e.g., in a configured recovery search space) to a recovery indication sent to the network entity 105 (e.g., a cell selected for recovery). In some other examples, the wireless repeater 205 may start the timer after sending the recovery indication. Such a recovery indication may include a message 1 (MSG1) or a message A (MSG-A) transmitted by the wireless repeater 205 (e.g., the MT functionality 210 of the wireless repeater 205) via a random access channel (RACH) (if BFR is for a PCell) or an SR (if BFR is for an SCell). Such a timer may be associated with a value indicative of a duration of the timer, where the value may be defined by a network specification, preconfigured (e.g., in a memory of the wireless repeater 205 or via RRC signaling), or signaled/indicated (e.g., via a MAC-CE or DCI) from the network entity 105 to the wireless repeater 205.

Additionally, or alternatively, the network entity 105 may transmit an explicit indication to the wireless repeater 205 to indicate, to the wireless repeater 205, whether the forwarding functionality 215 can become active (e.g., enter an ON state) following (e.g., in accordance with) a previous configuration of the forwarding functionality 215 or is expected to wait (e.g., in an OFF or inactive state) to receive a new indication (e.g., an RRC reconfiguration or updated/new/fresh side control information). The network entity 105 may transmit such an explicit indication along with or after a response to a recovery indication. In some examples, the explicit indication from the network entity 105 may indicate or provide an amount of time that the wireless repeater 205 is expected to wait to receive an RRC reconfiguration or updated side control information. In some examples, if the indicated amount of time passes or expires without reception of an RRC reconfiguration or updated/new/fresh side control information, the wireless repeater 205 may set the forwarding functionality 215 to an ON state.

Additionally, or alternatively, the wireless repeater 205 may support or define one or more rules based on which the wireless repeater 205 may autonomously decide whether to follow a previous configuration (e.g., to set the forwarding functionality 215 to an ON or active state) or to keep the forwarding functionality 215 in an OFF or inactive state until the wireless repeater 205 receives a new or updated configuration (e.g., an RRC reconfiguration or updated side control information). For example, if after the recovery a new beam, such as a beam between the network entity 105 and the MT functionality 210, is found and/or a set of (e.g., all of) the previous beam(s) have an unsatisfactory strength (e.g., below a threshold signal strength), the wireless repeater 205 may determine (e.g., identify, assume, or ascertain) that a new configuration is suitable and may keep the forwarding functionality 215 in an OFF or inactive state until the wireless repeater 205 receives an indication or configuration from the network entity 105 (e.g., from the cell selected for recovery). Otherwise (e.g., when temporarily a serving beam was blocked, but the same beam can be used after recovery), the wireless repeater 205 may determine (e.g., identify, assume, or ascertain) to follow a previous configuration of the forwarding functionality 215 and may set the forwarding functionality 215 to an ON or active state when the wireless repeater 205 completes the BFR (e.g., the forwarding functionality 215 may become active as soon as the wireless repeater 205 completes the BFR procedure).

In some examples, the one or more rules may depend on the underlying signals being configured for forwarding by the wireless repeater 205. For example, if the wireless repeater 205 is semi-statically configured to forward a set of resources (e.g., a set of resources carrying SSBs and/or associated RACH occasions or remaining minimum system information RMSI), the wireless repeater 205 may determine (e.g., identify, assume, or ascertain) whether to continue forwarding signaling via such resources (e.g., after BFR) or not depending on the recovered beams/SSB indices that can still be detected. In other words, if the wireless repeater 205 measures that a first set of reference signals have signal strengths greater than a threshold signal strength as part of the BFR procedure, the wireless repeater 205 may set the forwarding functionality 215 to an ON or active state if the first set of reference signals include a second set of reference signals associated with a previous configuration of the forwarding functionality 215 and may set the forwarding functionality 215 to an OFF or inactive state if the first set of reference signals do not include the second set of reference signals associated with the previous configuration of the forwarding functionality 215.

In some examples, the wireless repeater 205 may take a hybrid or partial approach with respect to whether the forwarding functionality 215 is set to an ON state or an OFF state based on whether the first set of reference signals include the second set of reference signals. For example, if the first set of reference signals includes a subset of the second set of reference signals, the wireless repeater 205 may set the forwarding functionality 215 to an ON state with respect to the subset of the second set of reference signals and may set the forwarding functionality 215 to an OFF state with respect to a remainder of the second set of reference signals. In other words, the wireless repeater 205 may determine to continue amplifying and forwarding signaling received via resources associated with the subset of the second set of reference signals and may determine to stop amplifying and forwarding signaling received via resources associated with the remainder of the second set of reference signals. In such examples, the wireless repeater 205 may signal via which resources or reference signals the wireless repeater 205 continues to amplify and forward signaling.

In some implementations, the MT functionality 210 of the wireless repeater 205 may indicate (e.g., via signaling) a choice or decision associated with setting the forwarding functionality 215 to an ON state or an OFF state (e.g., a choice or decision associated with whether the wireless repeater 205 will activate the forwarding functionality 215 immediately after the BFR procedure or wait for a new configuration or new side control information). In some examples, the MT functionality 210 may transmit the indication via a recovery indication (e.g., via a specific choice of RACH occasions and/or RACH preambles), via separate signaling prior to the recovery indication (e.g., via messaging exchanged during a connection establishment procedure), or via separate signaling after the recovery indication.

In some implementations, the MT functionality 210 may transmit a request for a reconfiguration or for a confirmation (e.g., a confirmation of a decision made by the wireless repeater 205 associated with setting the forwarding functionality 215 to an ON state or an OFF state or confirmation that a reconfiguration will not be forthcoming). In some implementations, the wireless repeater 205 may set the forwarding functionality 215 to an ON state or an OFF state via a specific mechanism or a specific combination of mechanisms in accordance with that specific mechanism or combination of mechanisms being specified in a network specification, being preconfigured or preloaded at the wireless repeater 205 (e.g., in a memory of the wireless repeater 205 or via RRC signaling), or being indicated or signaled (e.g., semi-statically or dynamically) to the wireless repeater 205. For example, the network entity 105 may indicate which specific mechanism or a specific combination of mechanisms the wireless repeater 205 is allowed to use to determine whether to set the forwarding functionality 215 to an ON state or an OFF state after a BFR procedure. In some implementations, the wireless repeater 205 may transmit an indication of a capability of the wireless repeater 205 associated with which specific mechanism or combination of mechanisms the wireless repeater 205 supports to determine (e.g., identify, assume, or ascertain) whether to set the forwarding functionality 215 to an ON state or an OFF state after BFR.

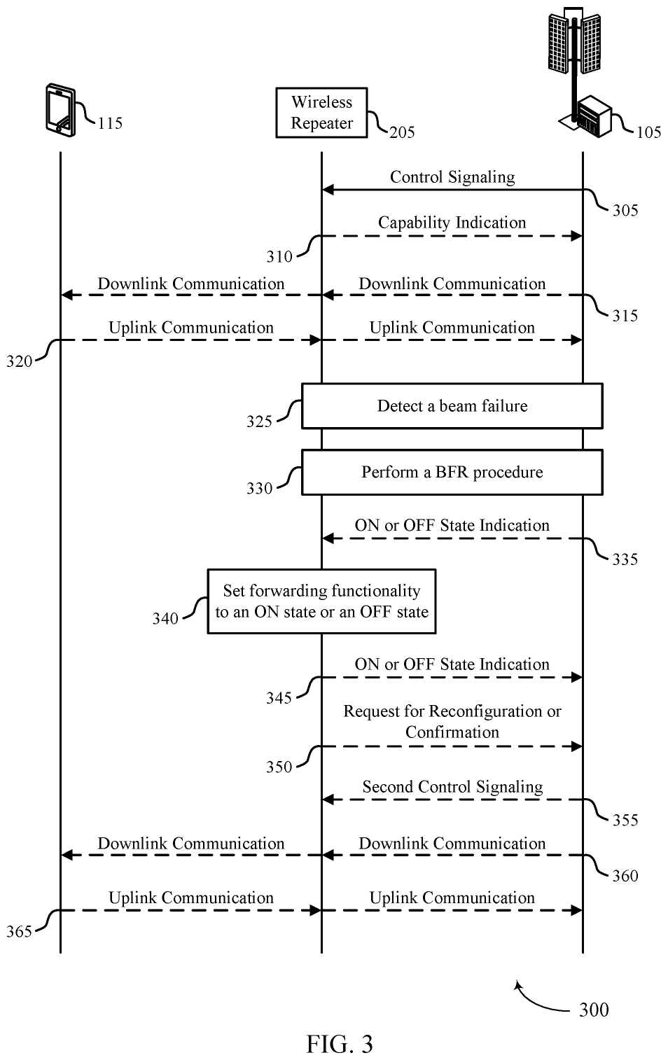

FIG. 3 illustrates an example of a process flow 300 that supports network-controlled repeater behavior following beam failure recovery in accordance with one or more aspects of the present disclosure. The process flow 300 may implement or be implemented to facilitate or realize aspects of the wireless communications system 100 or the signaling diagram 200. For example, the process flow 300 illustrates communication between a UE 115, a network entity 105, and a wireless repeater 205, which may be examples of corresponding devices illustrated and described herein, including by and with reference to FIGS. 1 and 2. In some implementations, the UE 115, the network entity 105, and the wireless repeater 205 may support one or more signaling- or configuration-based mechanisms associated with a behavior of the wireless repeater 205 (e.g., an NCR) during and/or after BFR at the wireless repeater 205.

In the following description of the process flow 300, the operations may be performed (such as reported or provided) in a different order than the order shown, or the operations performed by the example devices may be performed in different orders or at different times. Some operations also may be left out of the process flow 300, or other operations may be added to the process flow 300. Further, although some operations or signaling may be shown to occur at different times for discussion purposes, these operations may actually occur at the same time.

At 305, the wireless repeater 205 may receive, from the network entity 105 (e.g., at the MT functionality 210 of the wireless repeater 205), control signaling indicating at least one of a first configuration for directional communications between the wireless repeater 205 and the UE 115 or a second configuration for directional communications between the wireless repeater 205 and the network entity 105.

The first configuration for directional communications may refer to information indicative of one or more directional beams that the wireless repeater 205 uses to amplify and forward signaling to or from the UE 115. On the other hand, the second configuration for directional communications may refer to information indicative of one or more directional beams that the wireless repeater 205 uses to amplify and forward signaling to or from the network entity 105. The first configuration for directional communications or the second configuration for directional communications, or both, may include or be associated with periodic beamforming information (e.g., beamforming information indicative of or otherwise associated with a periodic transmission, such as an SSB transmission, between the UE 115 and the network entity 105), aperiodic beamforming information (e.g., beamforming information indicative of or otherwise associated with an aperiodic transmission between the UE 115 and the network entity 105), or semi-static beamforming information (e.g., beamforming information indicative of or otherwise associated with a semi-static transmission between the UE 115 and the network entity 105), or any combination thereof. As such, the control signaling may include any one or more of RRC signaling, one or more MAC-CEs, and DCI.

In some aspects, the first configuration for directional communications or the second configuration for directional communications, or both, may also include resource allocation information (e.g., time domain information) associated with when various directional beams are to be used by the wireless repeater 205. The control signaling may be transmitted via one or multiple messages, may overwrite or supplement previous configurations for directional communications, may be transmitted at approximately a same time or at various times, or any combination thereof.

At 310, the wireless repeater 205 may transmit, to the network entity 105 (e.g., via the MT functionality 210 of the wireless repeater 205), an indication of a capability of the wireless repeater 205 associated with setting the forwarding functionality 215 of the wireless repeater 205 to the ON state or the OFF state based on a BFR procedure. In some examples, the capability indication may be indicative of a specific one or more mechanisms, from a set of available mechanisms, according to which the wireless repeater 205 is able to determine whether to set the forwarding functionality 215 of the wireless repeater 205 to an ON state or an OFF state based on a BFR procedure.

The set of available mechanisms may be specified by a network specification, preconfigured or preloaded at the wireless repeater 205 (e.g., via RRC signaling or in a memory of the wireless repeater 205), or indicated by the network entity 105 (e.g., via a MAC-CE or DCI). In some aspects, along with or separate from the capability indication, the wireless repeater 205 may indicate a preferred one or more mechanisms from the set of available mechanisms and may monitor for an indication of which mechanism to use from the network entity 105 based on indicating the preferred one or more mechanisms. In such aspects, the network entity 105 may transmit an indication of which one or more mechanisms the wireless repeater 205 is expected to use based on receiving an indication of the one or more mechanisms preferred by the wireless repeater 205.

At 315, the wireless repeater 205 may relay, via the forwarding functionality 215 of the wireless repeater 205, downlink communication from the network entity 105 to the UE 115 in accordance with at least one of the first configuration for directional communications or the second configuration for directional communications. Such downlink communication may include periodic downlink communication, aperiodic downlink communication, or semi-static downlink communication. Likewise, the wireless repeater 205 may set the forwarding functionality 215 to an ON state for each slot during which downlink communication is scheduled, indicated, or configured (and may otherwise set the forwarding functionality 215 to an OFF state).

At 320, the wireless repeater 205 may relay, via the forwarding functionality 215 of the wireless repeater 205, uplink communication from the UE 115 to the network entity 105 in accordance with at least one of the first configuration for directional communications or the second configuration for directional communications. Such uplink communication may include periodic uplink communication, aperiodic uplink communication, or semi-static uplink communication. Likewise, the wireless repeater 205 may set the forwarding functionality 215 to an ON state for each slot during which uplink communication is scheduled, indicated, or configured (and may otherwise set the forwarding functionality 215 to an OFF state).

At 325, one or both of the wireless repeater 205 and the network entity 105 may detect a beam failure. For example, one or both of the wireless repeater 205 and the network entity 105 may detect a beam failure associated with the MT functionality 210 of the wireless repeater 205. In other words, the detected beam failure may involve one or more directional beams associated with a control link 220 between the MT functionality 210 and the network entity 105.

At 330, the wireless repeater 205 (e.g., the MT functionality 210 of the wireless repeater 205) and the network entity 105 may perform a BFR procedure to attempt to recover one or more directional beams and the control link 220. As part of the BFR procedure, the wireless repeater 205 (e.g., the MT functionality 210 of the wireless repeater 205) or the network entity 105, or both, may measure a set of reference signals transmitted by the other of the wireless repeater 205 and the network entity 105. In some aspects, as part of the BFR procedure, the wireless repeater 205 and the network entity 105 may exchange random access messaging (e.g., if the BFR procedure is associated with a PCell) or the wireless repeater 205 may transmit an SR (e.g., if the BFR procedure is associated with an SCell). For example, as part of the BFR procedure, the wireless repeater 205 may transmit a recovery indication, which may include a random access message or an SR.

At 335, the wireless repeater 205 may receive, from the network entity 105 at the MT functionality 210 of the wireless repeater 205, an indication of whether the wireless repeater 205 is to set the forwarding functionality 215 of the wireless repeater 205 to the ON state or the OFF state after the BFR procedure (e.g., after a successful BFR procedure, such as a BFR procedure that results in an identification of a directional beam and avoids RLF). In some aspects, the wireless repeater 205 may receive such an indication prior to the BFR procedure (e.g., during a connection establishment procedure or via other signaling, such as the control signaling received at 305). In some other aspects, the wireless repeater 205 may receive such an indication via a response to a recovery indication. In some other aspects, the wireless repeater 205 may receive such an indication via separate signaling after a response to a recovery indication. In some implementations, such an indication may also indicate a time period during which the wireless repeater 205 may wait (e.g., and monitor) for second control signaling associated with an updated configuration for directional communications.

Further, as described herein, such an indication may be an explicit indication to indicate to the wireless repeater 205 whether the forwarding functionality 215 can become active following (e.g., in accordance with) one or more previous configurations or is expected to wait to receive a new indication (e.g., second control signaling associated with an updated configuration for directional communications).

At 340, the wireless repeater 205 may set the forwarding functionality 215 of the wireless repeater 205 to an ON state or an OFF state based on the BFR procedure. In some implementations, the wireless repeater 205 may set the forwarding functionality 215 to an ON state or an OFF state in accordance with one or more signaling- or configuration-based mechanisms. Such one or more signaling- or configuration-based mechanisms are described in more detail with reference to FIG. 2.

At 345, the wireless repeater 205 may transmit, to the network entity 105 via the MT functionality 210 of the wireless repeater 205, an indication of a decision at the wireless repeater 205 to set the forwarding functionality 215 of the wireless repeater 205 to an ON state or an OFF state. The MT functionality 210 may indicate its choice (e.g., whether the MT functionality 210 will activate the forwarding functionality 215 immediately or wait) along with a recovery indication (e.g., via some specific choice of RACH occasions and/or RACH preambles), at a later time, or at a prior time.

At 350, the wireless repeater 205 may transmit, to the network entity 105 via the MT functionality 210 of the wireless repeater 205, a request for a confirmation by the network entity 105 of the decision at the wireless repeater 205 to set the forwarding functionality 215 of the wireless repeater 205 to an ON state or an OFF state. Additionally, or alternatively, the wireless repeater 205 may transmit, to the network entity 105 via the MT functionality 210 of the wireless repeater 205, a request for second control signaling indicating at least one of an updated first configuration for directional communications between the wireless repeater 205 and the UE 115 or an updated second configuration for directional communications between the wireless repeater 205 and the network entity 105, or both. Additionally, or alternatively, the wireless repeater 205 may transmit the request to receive a confirmation of whether the network entity 105 is expecting to transmit such second control signaling.

At 355, the wireless repeater 205 may receive, from the network entity 105 at the MT functionality 210 of the wireless repeater 205, second control signaling indicating at least one of an updated first configuration for directional communications between the wireless repeater 205 and the UE 115 or an updated second configuration for directional communications between the wireless repeater 205 and the network entity 105, or both, based on the BFR procedure. Such second control signaling may include RRC reconfiguration signaling and/or new (e.g., fresh, such as relatively recently received) side control information (e.g., via a MAC-CE or DCI).

In other words, the second control signaling may include an RRC reconfiguration message providing or indicating new periodic beamforming information, DCI providing or indicating new aperiodic beamforming information (e.g., referencing a beam or TCI state ID configured by RRC signaling previously), or a MAC-CE providing or indicating new semi-static beamforming information (e.g., referencing a beam or TCI state ID configured by RRC signaling previously). Accordingly, the second control signaling may provide a complete reconfiguration (e.g., via RRC) for directional communication at the wireless repeater 205 or may supplement a previous configuration for directional communication at the wireless repeater 205. In some aspects, the wireless repeater 205 may expect that a complete reconfiguration for the forwarding functionality 215 will not be forthcoming if the wireless repeater 205 receives second control signaling that references (e.g., references a TCI state ID of) a previous RRC configuration.

In some implementations, the wireless repeater 205 may set the forwarding functionality 215 to an ON state in accordance with the second control signaling. As such, the wireless repeater 205 may set the forwarding functionality 215 to an ON state for slots or symbols during which uplink or downlink communication is configured, indicated, or scheduled in accordance with the second control signaling.

At 360, the wireless repeater 205 may relay, via the forwarding functionality 215 of the wireless repeater 205, second downlink communication from the network entity 105 to the UE 115 in accordance with at least one of the updated first configuration for directional communications and the updated second configuration for directional communications. Such second downlink communication may include periodic downlink communication, aperiodic downlink communication, or semi-static downlink communication. Likewise, the wireless repeater 205 may set the forwarding functionality 215 to an ON state for each slot during which downlink communication is scheduled, indicated, or configured (and may otherwise set the forwarding functionality 215 to an OFF state).

At 365, the wireless repeater 205 may relay, via the forwarding functionality 215 of the wireless repeater 205, second uplink communication from the UE 115 to the network entity 105 in accordance with at least one of the updated first configuration for directional communications and the updated second configuration for directional communications. Such second uplink communication may include periodic uplink communication, aperiodic uplink communication, or semi-static uplink communication. Likewise, the wireless repeater 205 may set the forwarding functionality 215 to an ON state for each slot during which uplink communication is scheduled, indicated, or configured (and may otherwise set the forwarding functionality 215 to an OFF state).

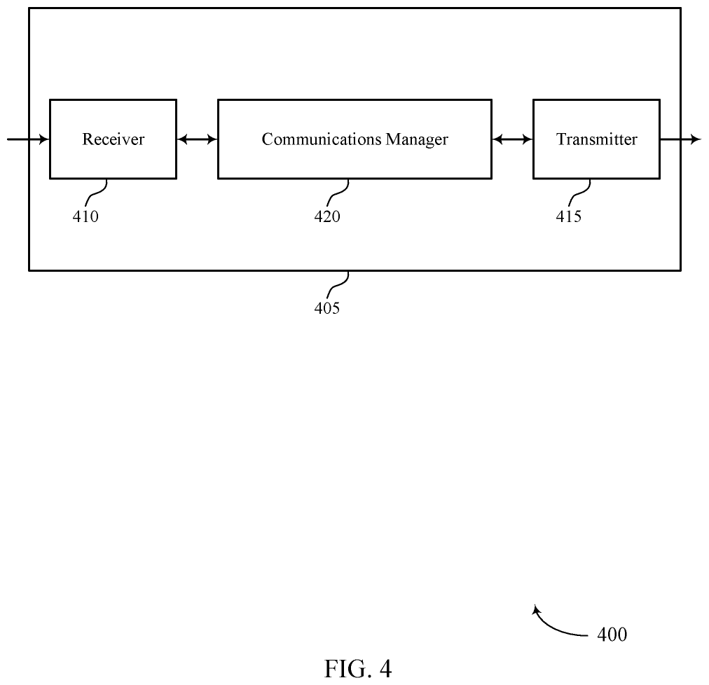

FIG. 4 illustrates a block diagram 400 of a device 405 that supports NCR behavior following BFR in accordance with one or more aspects of the present disclosure. The device 405 may be an example of aspects of a wireless repeater 205 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to NCR behavior following BFR). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to NCR behavior following BFR). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of NCR behavior following BFR as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a wireless repeater in accordance with examples as disclosed herein. For example, the communications manager 420 may be configured as or otherwise support a means for receiving, from a network entity at a MT functionality of the wireless repeater, control signaling indicating at least one of a first configuration for directional communications between the wireless repeater and a UE or a second configuration for directional communications between the wireless repeater and the network entity. The communications manager 420 may be configured as or otherwise support a means for relaying, via a forwarding functionality of the wireless repeater, uplink communication from the UE to the network entity or downlink communication from the network entity to the UE, or both, in accordance with at least one of the first configuration for directional communications or the second configuration for directional communications. The communications manager 420 may be configured as or otherwise support a means for performing, at the MT functionality of the wireless repeater, a BFR procedure in accordance with a beam failure associated with the MT functionality of the wireless repeater. The communications manager 420 may be configured as or otherwise support a means for setting the forwarding functionality of the wireless repeater to an ON state or an OFF state based on the BFR procedure.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing, reduced power consumption, and more efficient utilization of communication resources.

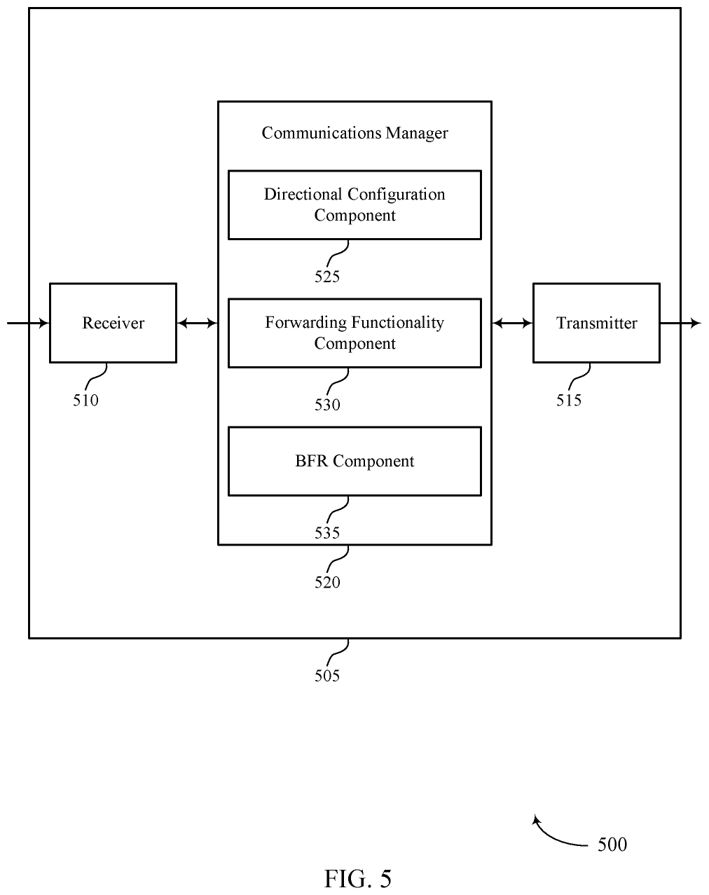

FIG. 5 illustrates a block diagram 500 of a device 505 that supports NCR behavior following BFR in accordance with one or more aspects of the present disclosure. The device 505 may be an example of aspects of a device 405 or a wireless repeater 205 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to NCR behavior following BFR). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to NCR behavior following BFR). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of NCR behavior following BFR as described herein. For example, the communications manager 520 may include a directional configuration component 525, a forwarding functionality component 530, an BFR component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a wireless repeater in accordance with examples as disclosed herein. The directional configuration component 525 may be configured as or otherwise support a means for receiving, from a network entity at a MT functionality of the wireless repeater, control signaling indicating at least one of a first configuration for directional communications between the wireless repeater and a UE or a second configuration for directional communications between the wireless repeater and the network entity. The forwarding functionality component 530 may be configured as or otherwise support a means for relaying, via a forwarding functionality of the wireless repeater, uplink communication from the UE to the network entity or downlink communication from the network entity to the UE, or both, in accordance with at least one of the first configuration for directional communications or the second configuration for directional communications. The BFR component 535 may be configured as or otherwise support a means for performing, at the MT functionality of the wireless repeater, a BFR procedure in accordance with a beam failure associated with the MT functionality of the wireless repeater. The forwarding functionality component 530 may be configured as or otherwise support a means for setting the forwarding functionality of the wireless repeater to an ON state or an OFF state based on the BFR procedure.

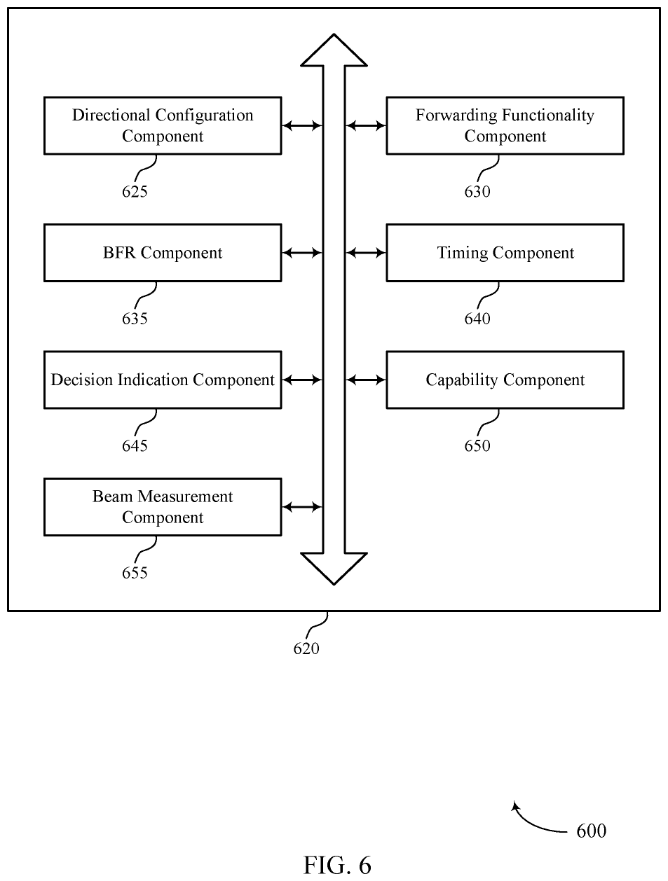

FIG. 6 illustrates a block diagram 600 of a communications manager 620 that supports NCR behavior following BFR in accordance with one or more aspects of the present disclosure. The communications manager 620 may be an example of aspects of a communications manager 420, a communications manager 520, or both, as described herein. The communications manager 620, or various components thereof, may be an example of means for performing various aspects of NCR behavior following BFR as described herein. For example, the communications manager 620 may include a directional configuration component 625, a forwarding functionality component 630, an BFR component 635, a timing component 640, a decision indication component 645, a capability component 650, a beam measurement component 655, or any combination thereof. Each of these components may communicate, directly or indirectly, with one another (e.g., via one or more buses).

The communications manager 620 may support wireless communication at a wireless repeater in accordance with examples as disclosed herein. The directional configuration component 625 may be configured as or otherwise support a means for receiving, from a network entity at a MT functionality of the wireless repeater, control signaling indicating at least one of a first configuration for directional communications between the wireless repeater and a UE or a second configuration for directional communications between the wireless repeater and the network entity. The forwarding functionality component 630 may be configured as or otherwise support a means for relaying, via a forwarding functionality of the wireless repeater, uplink communication from the UE to the network entity or downlink communication from the network entity to the UE, or both, in accordance with at least one of the first configuration for directional communications or the second configuration for directional communications. The BFR component 635 may be configured as or otherwise support a means for performing, at the MT functionality of the wireless repeater, a BFR procedure in accordance with a beam failure associated with the MT functionality of the wireless repeater. In some examples, the forwarding functionality component 630 may be configured as or otherwise support a means for setting the forwarding functionality of the wireless repeater to an ON state or an OFF state based on the BFR procedure.

In some examples, to support setting the forwarding functionality of the wireless repeater to the ON state or the OFF state, the forwarding functionality component 630 may be configured as or otherwise support a means for setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both.

In some examples, to support setting the forwarding functionality of the wireless repeater to the ON state or the OFF state, the timing component 640 may be configured as or otherwise support a means for starting a timer in accordance with performing the BFR procedure. In some examples, to support setting the forwarding functionality of the wireless repeater to the ON state or the OFF state, the forwarding functionality component 630 may be configured as or otherwise support a means for setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both, or an expiration of the timer.

In some examples, the BFR component 635 may be configured as or otherwise support a means for transmitting, to the network entity via the MT functionality of the wireless repeater, a recovery indication in accordance with the BFR procedure. In some examples, the BFR component 635 may be configured as or otherwise support a means for receiving, from the network entity at the MT functionality of the wireless repeater, a response to the recovery indication in accordance with the BFR procedure, where the wireless repeater starts the timer based on receiving the response to the recovery indication.

In some examples, the BFR component 635 may be configured as or otherwise support a means for transmitting, to the network entity via the MT functionality of the wireless repeater, a recovery indication in accordance with the BFR procedure, where the wireless repeater starts the timer based on transmitting the recovery indication.

In some examples, the forwarding functionality component 630 may be configured as or otherwise support a means for receiving, from the network entity at the MT functionality of the wireless repeater, an indication of whether the wireless repeater is to set the forwarding functionality of the wireless repeater to the ON state or the OFF state after the BFR procedure.

In some examples, to support receiving the indication from the network entity, the forwarding functionality component 630 may be configured as or otherwise support a means for receiving the indication via a response to a recovery indication associated with the BFR procedure.

In some examples, to support receiving the indication from the network entity, the forwarding functionality component 630 may be configured as or otherwise support a means for receiving the indication via separate signaling after a response to a recovery indication associated with the BFR procedure.

In some examples, the indication is to set the forwarding functionality of the wireless repeater to the OFF state for a time period after the BFR procedure. In some examples, the wireless repeater monitors for second control signaling indicating at least one of an updated first configuration for directional communications between the wireless repeater and the UE or an updated second configuration for directional communications between the wireless repeater and the network entity, or both, for a duration of the time period.

In some examples, to support setting the forwarding functionality of the wireless repeater to the ON state or the OFF state, the forwarding functionality component 630 may be configured as or otherwise support a means for autonomously setting the forwarding functionality of the wireless repeater to the ON state or the OFF state based on a rule-based decision at the wireless repeater.

In some examples, the beam measurement component 655 may be configured as or otherwise support a means for measuring, as part of performing the BFR procedure, a set of reference signals associated with a set of directional beams, where a respective reference signal of the set of reference signals is associated with a respective directional beam of the set of directional beams. In some examples, the forwarding functionality component 630 may be configured as or otherwise support a means for setting the forwarding functionality of the wireless repeater to the ON state or the OFF state based on a set of measurements of the set of directional beams, where the rule-based decision at the wireless repeater is associated with the set of measurements.

In some examples, the beam measurement component 655 may be configured as or otherwise support a means for identifying that one or more directional beams associated with the MT functionality of the wireless repeater have signal strengths below a threshold signal strength in accordance with measuring the set of reference signals, where the wireless repeater sets the forwarding functionality of the wireless repeater to the OFF state in accordance with identifying that the one or more directional beams have the signal strengths below the threshold signal strength.

In some examples, the beam measurement component 655 may be configured as or otherwise support a means for identifying a new directional beam for communications between the wireless repeater and the network entity in accordance with measuring the set of reference signals, where the wireless repeater sets the forwarding functionality of the wireless repeater to the OFF state in accordance with identifying the new directional beam for the communications between the wireless repeater and the network entity.

In some examples, the beam measurement component 655 may be configured as or otherwise support a means for identifying a same directional beam for communications between the wireless repeater and the network entity as was previously associated with the MT functionality of the wireless repeater in accordance with measuring the set of reference signals, where the wireless repeater sets the forwarding functionality of the wireless repeater to the ON state in accordance with identifying the same directional beam.

In some examples, the beam measurement component 655 may be configured as or otherwise support a means for identifying, based on measuring the set of reference signals, a first set of one or more directional beams of the set of directional beams that have signal strengths above a threshold signal strength. In some examples, the forwarding functionality component 630 may be configured as or otherwise support a means for setting the forwarding functionality of the wireless repeater to the ON state or the OFF state based on a comparison between the first set of one or more directional beams and a second set of one or more directional beams associated with the first configuration for directional communications or the second configuration for directional communications, or both.

In some examples, to support setting the forwarding functionality of the wireless repeater to the ON state or the OFF state, the forwarding functionality component 630 may be configured as or otherwise support a means for setting the forwarding functionality of the wireless repeater to the ON state based on the first set of one or more directional beams including an entirety of the second set of one or more directional beams. In some examples, to support setting the forwarding functionality of the wireless repeater to the ON state or the OFF state, the forwarding functionality component 630 may be configured as or otherwise support a means for setting the forwarding functionality of the wireless repeater to the OFF state based on the first set of one or more directional beams failing to include the entirety of the second set of one or more directional beams.

In some examples, the first set of one or more directional beams includes a subset of the second set of one or more directional beams. In some examples, the wireless repeater sets the forwarding functionality of the wireless repeater to the ON state with respect to the subset of the second set of one or more directional beams and sets the forwarding functionality of the wireless repeater to the OFF state with respect to a remainder of the second set of one or more directional beams.

In some examples, the decision indication component 645 may be configured as or otherwise support a means for transmitting, to the network entity via the MT functionality of the wireless repeater, an indication of a decision at the wireless repeater to set the forwarding functionality of the wireless repeater to the ON state or the OFF state.

In some examples, the forwarding functionality component 630 may be configured as or otherwise support a means for transmitting, to the network entity via the MT functionality of the wireless repeater, a request for confirmation by the network entity of the decision at the wireless repeater to set the forwarding functionality of the wireless repeater to the ON state or the OFF state.

In some examples, the directional configuration component 625 may be configured as or otherwise support a means for transmitting, to the network entity via the MT functionality of the wireless repeater, a request for second control signaling indicating at least one of an updated first configuration for directional communications between the wireless repeater and the UE or an updated second configuration for directional communications between the wireless repeater and the network entity, or both.

In some examples, the directional configuration component 625 may be configured as or otherwise support a means for receiving, from the network entity at the MT functionality of the wireless repeater, second control signaling indicating at least one of an updated first configuration for directional communications between the wireless repeater and the UE or an updated second configuration for directional communications between the wireless repeater and the network entity, or both, based on the BFR procedure. In some examples, the forwarding functionality component 630 may be configured as or otherwise support a means for setting the forwarding functionality of the wireless repeater to the ON state in accordance with receiving the second control signaling. In some examples, the forwarding functionality component 630 may be configured as or otherwise support a means for relaying, via the forwarding functionality of the wireless repeater, second uplink communication from the UE to the network entity or second downlink communication from the network entity to the UE, or both, in accordance with at least one of the updated first configuration for directional communications and the updated second configuration for directional communications.

In some examples, the capability component 650 may be configured as or otherwise support a means for transmitting, to the network entity via the MT functionality of the wireless repeater, an indication of a capability of the wireless repeater associated with setting the forwarding functionality of the wireless repeater to the ON state or the OFF state based on the BFR procedure.

In some examples, the capability is indicative of a specific one or more mechanisms, from a set of mechanisms, according to which the wireless repeater is able to determine whether to set the forwarding functionality of the wireless repeater to the ON state or the OFF state based on the BFR procedure.

In some examples, setting the forwarding functionality of the wireless repeater to the ON state is associated with a continued use of at least one of the first configuration for directional communications between the wireless repeater and the UE or the second configuration for directional communications between the wireless repeater and the network entity after the BFR procedure. In some examples, the wireless repeater continues to relay communications between the UE and the network entity if the forwarding functionality of the wireless repeater is set to the ON state.

In some examples, setting the forwarding functionality of the wireless repeater to the OFF state is associated with a waiting for second control signaling indicating at least one of an updated first configuration for directional communications between the wireless repeater and the UE or an updated second configuration for directional communications between the wireless repeater and the network entity, or both. In some examples, the wireless repeater refrains from relaying communications between the UE and the network entity if the forwarding functionality of the wireless repeater is set to the OFF state.

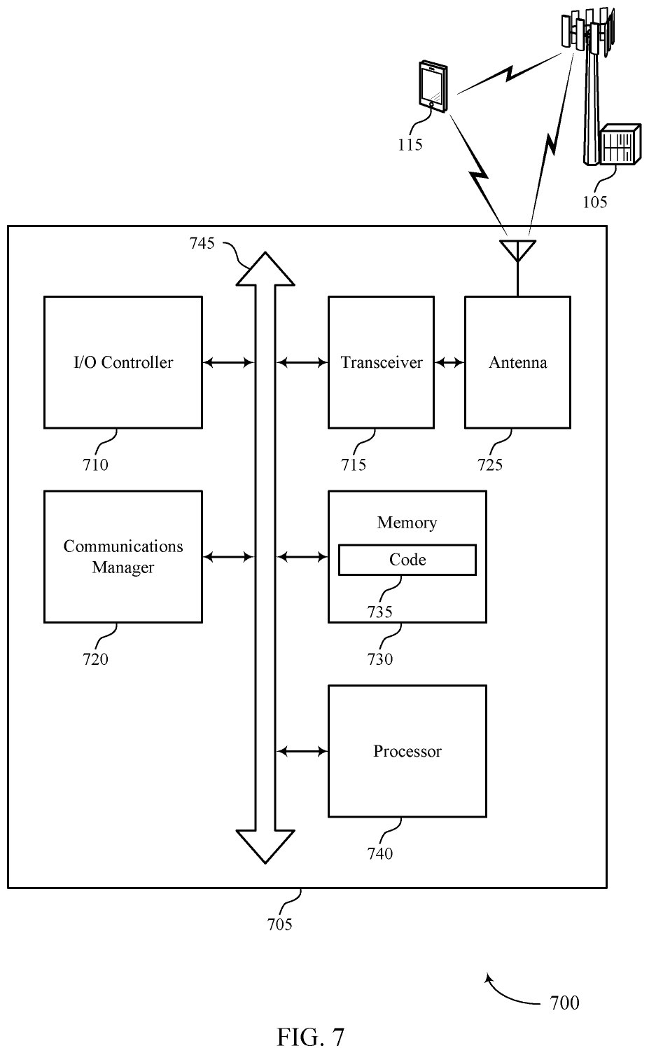

FIG. 7 illustrates a diagram of a system 700 including a device 705 that supports NCR behavior following BFR in accordance with one or more aspects of the present disclosure. The device 705 may be an example of or include the components of a device 405, a device 505, or a wireless repeater 205 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM) (e.g., one or more memories). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting NCR behavior following BFR). For example, the device 705 or a component of the device 705 may include a processor 740 and memory 730 coupled with or to the processor 740, the processor 740 and memory 730 configured to perform various functions described herein.

The communications manager 720 may support wireless communication at a wireless repeater in accordance with examples as disclosed herein. For example, the communications manager 720 may be configured as or otherwise support a means for receiving, from a network entity at a MT functionality of the wireless repeater, control signaling indicating at least one of a first configuration for directional communications between the wireless repeater and a UE or a second configuration for directional communications between the wireless repeater and the network entity. The communications manager 720 may be configured as or otherwise support a means for relaying, via a forwarding functionality of the wireless repeater, uplink communication from the UE to the network entity or downlink communication from the network entity to the UE, or both, in accordance with at least one of the first configuration for directional communications or the second configuration for directional communications. The communications manager 720 may be configured as or otherwise support a means for performing, at the MT functionality of the wireless repeater, a BFR procedure in accordance with a beam failure associated with the MT functionality of the wireless repeater. The communications manager 720 may be configured as or otherwise support a means for setting the forwarding functionality of the wireless repeater to an ON state or an OFF state based on the BFR procedure.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of NCR behavior following BFR as described herein, or the processor 740 and the memory 730 may be otherwise configured to perform or support such operations.

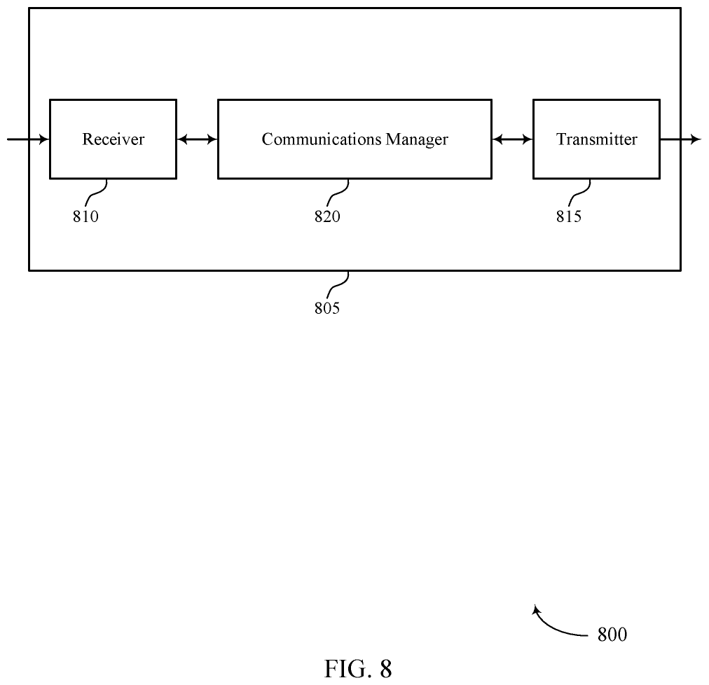

FIG. 8 illustrates a block diagram 800 of a device 805 that supports NCR behavior following BFR in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of NCR behavior following BFR as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity. The communications manager 820 may be configured as or otherwise support a means for participating in uplink communication from the UE to the network entity via the forwarding functionality of the wireless repeater or downlink communication from the network entity to the UE via the forwarding functionality of the wireless repeater, or both. The communications manager 820 may be configured as or otherwise support a means for performing a BFR procedure in accordance with a beam failure associated with the MT functionality of the wireless repeater. The communications manager 820 may be configured as or otherwise support a means for communicating with the wireless repeater in accordance with a setting of the forwarding functionality of the wireless repeater to an ON state or an OFF state based on the BFR procedure.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources.

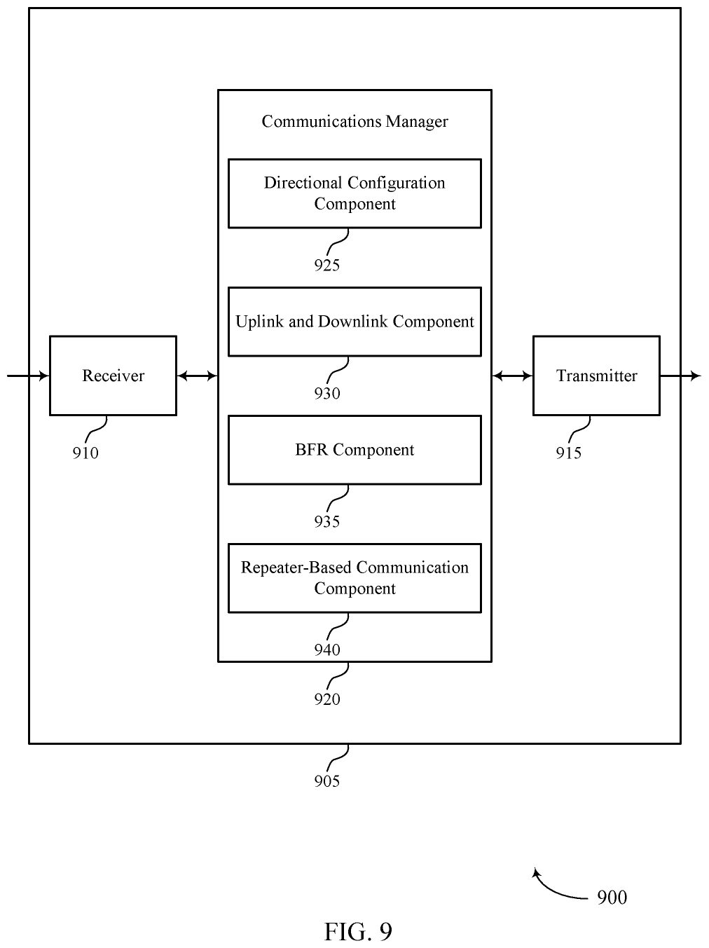

FIG. 9 illustrates a block diagram 900 of a device 905 that supports NCR behavior following BFR in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of NCR behavior following BFR as described herein. For example, the communications manager 920 may include a directional configuration component 925, an uplink and downlink component 930, an BFR component 935, a repeater-based communication component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The directional configuration component 925 may be configured as or otherwise support a means for outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity. The uplink and downlink component 930 may be configured as or otherwise support a means for participating in uplink communication from the UE to the network entity via the forwarding functionality of the wireless repeater or downlink communication from the network entity to the UE via the forwarding functionality of the wireless repeater, or both. The BFR component 935 may be configured as or otherwise support a means for performing a BFR procedure in accordance with a beam failure associated with the MT functionality of the wireless repeater. The repeater-based communication component 940 may be configured as or otherwise support a means for communicating with the wireless repeater in accordance with a setting of the forwarding functionality of the wireless repeater to an ON state or an OFF state based on the BFR procedure.

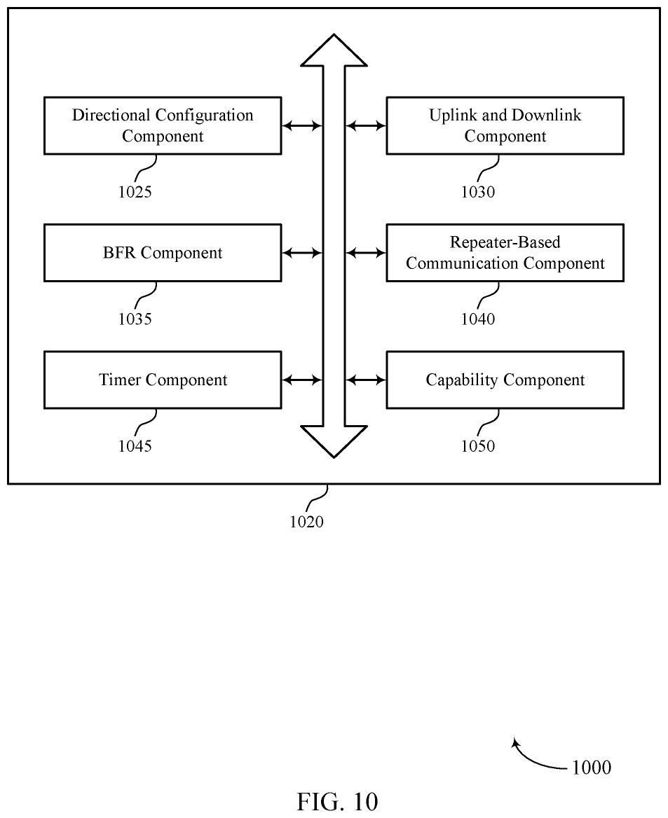

FIG. 10 illustrates a block diagram 1000 of a communications manager 1020 that supports NCR behavior following BFR in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of NCR behavior following BFR as described herein. For example, the communications manager 1020 may include a directional configuration component 1025, an uplink and downlink component 1030, an BFR component 1035, a repeater-based communication component 1040, a timer component 1045, a capability component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The directional configuration component 1025 may be configured as or otherwise support a means for outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity. The uplink and downlink component 1030 may be configured as or otherwise support a means for participating in uplink communication from the UE to the network entity via the forwarding functionality of the wireless repeater or downlink communication from the network entity to the UE via the forwarding functionality of the wireless repeater, or both. The BFR component 1035 may be configured as or otherwise support a means for performing a BFR procedure in accordance with a beam failure associated with the MT functionality of the wireless repeater. The repeater-based communication component 1040 may be configured as or otherwise support a means for communicating with the wireless repeater in accordance with a setting of the forwarding functionality of the wireless repeater to an ON state or an OFF state based on the BFR procedure.

In some examples, the timer component 1045 may be configured as or otherwise support a means for starting a timer in accordance with performing the BFR procedure. In some examples, the repeater-based communication component 1040 may be configured as or otherwise support a means for expecting the forwarding functionality of the wireless repeater to be set to the OFF state until the network entity transmits second control signaling indicating at least one of an updated first configuration for directional communications between the wireless repeater and the UE or an updated second configuration for directional communications between the wireless repeater and the network entity, or both, or an expiration of the timer.

In some examples, the BFR component 1035 may be configured as or otherwise support a means for obtaining, from the MT functionality of the wireless repeater, a recovery indication in accordance with the BFR procedure. In some examples, the BFR component 1035 may be configured as or otherwise support a means for outputting, to the MT functionality of the wireless repeater, a response to the recovery indication in accordance with the BFR procedure, where the network entity starts the timer based on outputting the response to the recovery indication.

In some examples, the BFR component 1035 may be configured as or otherwise support a means for obtaining, from the MT functionality of the wireless repeater, a recovery indication in accordance with the BFR procedure, where the network entity starts the timer based on obtaining the recovery indication.

In some examples, the repeater-based communication component 1040 may be configured as or otherwise support a means for outputting, to the MT functionality of the wireless repeater, an indication of whether the wireless repeater is to set the forwarding functionality of the wireless repeater to the ON state or the OFF state after the BFR procedure.

In some examples, to support transmitting the indication to the wireless repeater, the repeater-based communication component 1040 may be configured as or otherwise support a means for outputting the indication via a response to a recovery indication associated with the BFR procedure.

In some examples, to support transmitting the indication to the wireless repeater, the repeater-based communication component 1040 may be configured as or otherwise support a means for outputting the indication via separate signaling after a response to a recovery indication associated with the BFR procedure.

In some examples, the indication is to set the forwarding functionality of the wireless repeater to the OFF state for a time period after the BFR procedure. In some examples, the network entity selectively outputs second control signaling indicating at least one of an updated first configuration for directional communications between the wireless repeater and the UE or an updated second configuration for directional communications between the wireless repeater and the network entity, or both, during the time period.

In some examples, the repeater-based communication component 1040 may be configured as or otherwise support a means for obtaining, from the MT functionality of the wireless repeater, an indication of a decision at the wireless repeater to set the forwarding functionality of the wireless repeater to the ON state or the OFF state.

In some examples, the repeater-based communication component 1040 may be configured as or otherwise support a means for obtaining, from the MT functionality of the wireless repeater, a request for confirmation by the network entity of the decision at the wireless repeater to set the forwarding functionality of the wireless repeater to the ON state or the OFF state.

In some examples, the directional configuration component 1025 may be configured as or otherwise support a means for obtaining, from the MT functionality of the wireless repeater, a request for second control signaling indicating at least one of an updated first configuration for directional communications between the wireless repeater and the UE or an updated second configuration for directional communications between the wireless repeater and the network entity, or both.

In some examples, the capability component 1050 may be configured as or otherwise support a means for obtaining, from the MT functionality of the wireless repeater, an indication of a capability of the wireless repeater associated with setting the forwarding functionality of the wireless repeater to the ON state or the OFF state based on the BFR procedure.

In some examples, the setting of the forwarding functionality of the wireless repeater to the ON state is associated with a continued use of at least one of the first configuration for directional communications between the wireless repeater and the UE or the second configuration for directional communications between the wireless repeater and the network entity after the BFR procedure. In some examples, the wireless repeater continues to relay communications between the UE and the network entity if the forwarding functionality of the wireless repeater is set to the ON state.

In some examples, the setting of the forwarding functionality of the wireless repeater to the OFF state is associated with a selective transmission of second control signaling indicating at least one of an updated first configuration for directional communications between the wireless repeater and the UE or an updated second configuration for directional communications between the wireless repeater and the network entity, or both. In some examples, the wireless repeater refrains from relaying communications between the UE and the network entity if the forwarding functionality of the wireless repeater is set to the OFF state.

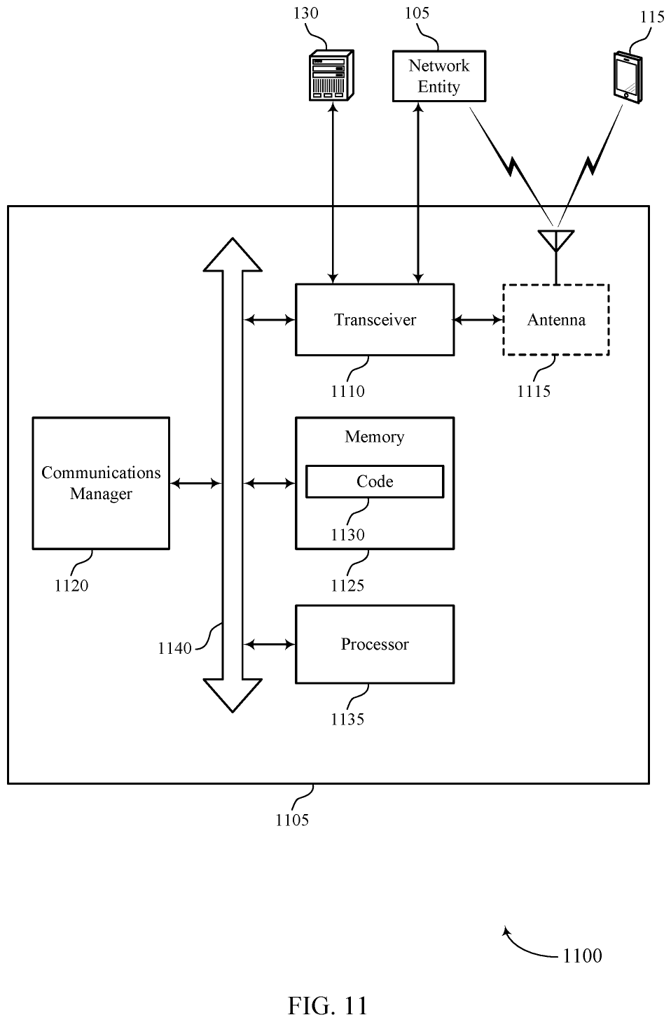

FIG. 11 illustrates a diagram of a system 1100 including a device 1105 that supports NCR behavior following BFR in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components (e.g., one or more memories) that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM (e.g., one or more memories). The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting NCR behavior following BFR). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system.

A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations.

In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity. The communications manager 1120 may be configured as or otherwise support a means for participating in uplink communication from the UE to the network entity via the forwarding functionality of the wireless repeater or downlink communication from the network entity to the UE via the forwarding functionality of the wireless repeater, or both. The communications manager 1120 may be configured as or otherwise support a means for performing a BFR procedure in accordance with a beam failure associated with the MT functionality of the wireless repeater. The communications manager 1120 may be configured as or otherwise support a means for communicating with the wireless repeater in accordance with a setting of the forwarding functionality of the wireless repeater to an ON state or an OFF state based on the BFR procedure.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of NCR behavior following BFR as described herein, or the processor 1135 and the memory 1125 may be otherwise configured to perform or support such operations.

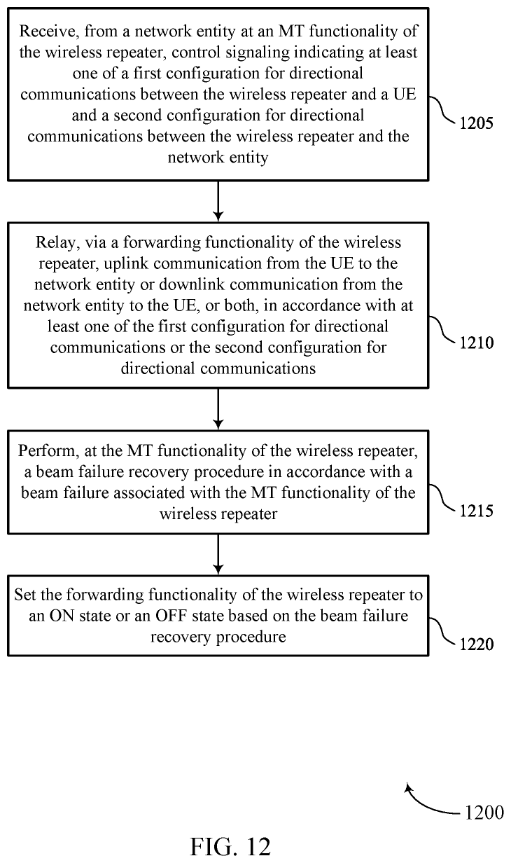

FIG. 12 illustrates a flowchart showing a method 1200 that supports NCR behavior following BFR in accordance with one or more aspects of the present disclosure. The operations of the method 1200 may be implemented by a wireless repeater or its components as described herein. For example, the operations of the method 1200 may be performed by a wireless repeater (e.g., a wireless repeater 205) as described with reference to FIGS. 1 through 7. In some examples, a wireless repeater may execute a set of instructions to control the functional elements of the wireless repeater to perform the described functions. Additionally, or alternatively, the wireless repeater may perform aspects of the described functions using special-purpose hardware.

At 1205, the method may include receiving, from a network entity at a MT functionality of the wireless repeater, control signaling indicating at least one of a first configuration for directional communications between the wireless repeater and a UE or a second configuration for directional communications between the wireless repeater and the network entity. The operations of 1205 may be performed in accordance with examples as disclosed herein. In some examples, aspects of the operations of 1205 may be performed by a directional configuration component 625 as described with reference to FIG. 6.

At 1210, the method may include relaying, via a forwarding functionality of the wireless repeater, uplink communication from the UE to the network entity or downlink communication from the network entity to the UE, or both, in accordance with at least one of the first configuration for directional communications or the second configuration for directional communications. The operations of 1210 may be performed in accordance with examples as disclosed herein. In some examples, aspects of the operations of 1210 may be performed by a forwarding functionality component 630 as described with reference to FIG. 6.

At 1215, the method may include performing, at the MT functionality of the wireless repeater, a BFR procedure in accordance with a beam failure associated with the MT functionality of the wireless repeater. The operations of 1215 may be performed in accordance with examples as disclosed herein. In some examples, aspects of the operations of 1215 may be performed by an BFR component 635 as described with reference to FIG. 6.

At 1220, the method may include setting the forwarding functionality of the wireless repeater to an ON state or an OFF state based on the BFR procedure. The operations of 1220 may be performed in accordance with examples as disclosed herein. In some examples, aspects of the operations of 1220 may be performed by a forwarding functionality component 630 as described with reference to FIG. 6.

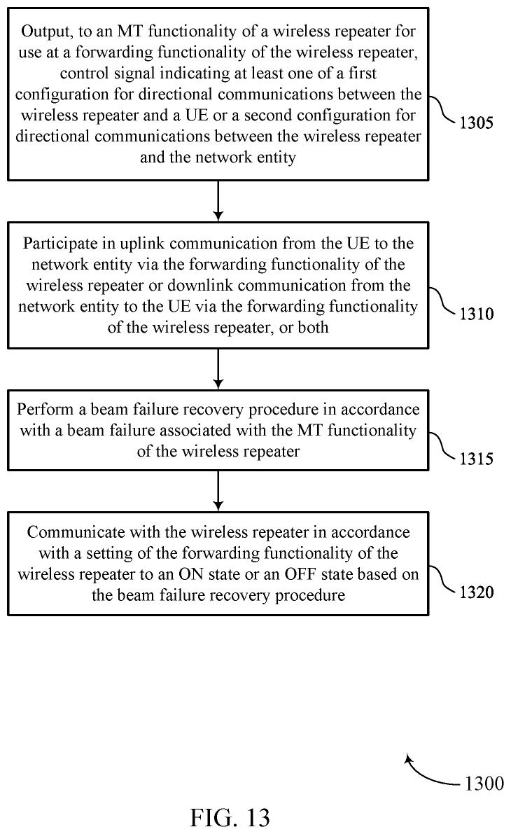

FIG. 13 illustrates a flowchart showing a method 1300 that supports NCR behavior following BFR in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting, to a MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity. The operations of 1305 may be performed in accordance with examples as disclosed herein. In some examples, aspects of the operations of 1305 may be performed by a directional configuration component 1025 as described with reference to FIG. 10.

At 1310, the method may include participating in uplink communication from the UE to the network entity via the forwarding functionality of the wireless repeater or downlink communication from the network entity to the UE via the forwarding functionality of the wireless repeater, or both. The operations of 1310 may be performed in accordance with examples as disclosed herein. In some examples, aspects of the operations of 1310 may be performed by an uplink and downlink component 1030 as described with reference to FIG. 10.

At 1315, the method may include performing a BFR procedure in accordance with a beam failure associated with the MT functionality of the wireless repeater. The operations of 1315 may be performed in accordance with examples as disclosed herein. In some examples, aspects of the operations of 1315 may be performed by an BFR component 1035 as described with reference to FIG. 10.

At 1320, the method may include communicating with the wireless repeater in accordance with a setting of the forwarding functionality of the wireless repeater to an ON state or an OFF state based on the BFR procedure. The operations of 1320 may be performed in accordance with examples as disclosed herein. In some examples, aspects of the operations of 1320 may be performed by a repeater-based communication component 1040 as described with reference to FIG. 10.

The following provides an overview of aspects of the present disclosure:
Aspect 1: A method for wireless communication at a wireless repeater, comprising: receiving, from a network entity at an MT functionality of the wireless repeater, control signaling indicating at least one of a first configuration for directional communications between the wireless repeater and a UE or a second configuration for directional communications between the wireless repeater and the network entity; relaying, via a forwarding functionality of the wireless repeater, uplink communication from the UE to the network entity or downlink communication from the network entity to the UE, or both, in accordance with at least one of the first configuration for directional communications or the second configuration for directional communications; performing, at the MT functionality of the wireless repeater, a BFR procedure in accordance with a beam failure associated with the MT functionality of the wireless repeater; and setting the forwarding functionality of the wireless repeater to an ON state or an OFF state based at least in part on the BFR procedure.
Aspect 2: The method of aspect 1, wherein setting the forwarding functionality of the wireless repeater to the ON state or the OFF state further comprises: setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both.
Aspect 3: The method of any of aspects 1 through 2, wherein setting the forwarding functionality of the wireless repeater to the ON state or the OFF state further comprises: starting a timer in accordance with performing the BFR procedure; and setting the forwarding functionality of the wireless repeater to the OFF state until: second control signaling indicates at least one of an updated first configuration for directional communications between the wireless repeater and the UE or an updated second configuration for directional communications between the wireless repeater and the network entity, or both; or an expiration of the timer.
Aspect 4: The method of aspect 3, further comprising: transmitting, to the network entity via the MT functionality of the wireless repeater, a recovery indication in accordance with the BFR procedure; and receiving, from the network entity at the MT functionality of the wireless repeater, a response to the recovery indication in accordance with the BFR procedure, wherein the wireless repeater starts the timer based at least in part on receiving the response to the recovery indication.
Aspect 5: The method of aspect 3, further comprising: transmitting, to the network entity via the MT functionality of the wireless repeater, a recovery indication in accordance with the BFR procedure, wherein the wireless repeater starts the timer based at least in part on transmitting the recovery indication.
Aspect 6: The method of any of aspects 1 through 5, further comprising: receiving, from the network entity at the MT functionality of the wireless repeater, an indication of whether the wireless repeater is to set the forwarding functionality of the wireless repeater to the ON state or the OFF state after the BFR procedure.
Aspect 7: The method of aspect 6, wherein receiving the indication from the network entity further comprises: receiving the indication via a response to a recovery indication associated with the BFR procedure.
Aspect 8: The method of aspect 6, wherein receiving the indication from the network entity further comprises: receiving the indication via separate signaling after a response to a recovery indication associated with the BFR procedure.
Aspect 9: The method of any of aspects 6 through 8, wherein the indication is to set the forwarding functionality of the wireless repeater to the OFF state for a time period after the BFR procedure, and the wireless repeater monitors for second control signaling indicating at least one of an updated first configuration for directional communications between the wireless repeater and the UE or an updated second configuration for directional communications between the wireless repeater and the network entity, or both, for a duration of the time period.
Aspect 10: The method of any of aspects 1 through 9, wherein setting the forwarding functionality of the wireless repeater to the ON state or the OFF state further comprises: autonomously setting the forwarding functionality of the wireless repeater to the ON state or the OFF state based at least in part on a rule-based decision at the wireless repeater.
Aspect 11: The method of aspect 10, further comprising: measuring, as part of performing the BFR procedure, a set of reference signals associated with a set of directional beams, wherein a respective reference signal of the set of reference signals is associated with a respective directional beam of the set of directional beams; and setting the forwarding functionality of the wireless repeater to the ON state or the OFF state based at least in part on a set of measurements of the set of directional beams, wherein the rule-based decision at the wireless repeater is associated with the set of measurements.
Aspect 12: The method of aspect 11, further comprising: identifying that one or more directional beams associated with the MT functionality of the wireless repeater have signal strengths below a threshold signal strength in accordance with measuring the set of reference signals, wherein the wireless repeater sets the forwarding functionality of the wireless repeater to the OFF state in accordance with identifying that the one or more directional beams have the signal strengths below the threshold signal strength.
Aspect 13: The method of any of aspects 11 through 12, further comprising: identifying a new directional beam for communications between the wireless repeater and the network entity in accordance with measuring the set of reference signals, wherein the wireless repeater sets the forwarding functionality of the wireless repeater to the OFF state in accordance with identifying the new directional beam for the communications between the wireless repeater and the network entity.
Aspect 14: The method of aspect 11, further comprising: identifying a same directional beam for communications between the wireless repeater and the network entity as was previously associated with the MT functionality of the wireless repeater in accordance with measuring the set of reference signals, wherein the wireless repeater sets the forwarding functionality of the wireless repeater to the ON state in accordance with identifying the same directional beam.
Aspect 15: The method of any of aspects 11 through 14, further comprising: identifying, based at least in part on measuring the set of reference signals, a first set of one or more directional beams of the set of directional beams that have signal strengths above a threshold signal strength; and setting the forwarding functionality of the wireless repeater to the ON state or the OFF state based at least in part on a comparison between the first set of one or more directional beams and a second set of one or more directional beams associated with the first configuration for directional communications or the second configuration for directional communications, or both.
Aspect 16: The method of aspect 15, wherein setting the forwarding functionality of the wireless repeater to the ON state or the OFF state further comprises: setting the forwarding functionality of the wireless repeater to the ON state based at least in part on the first set of one or more directional beams including an entirety of the second set of one or more directional beams; or setting the forwarding functionality of the wireless repeater to the OFF state based at least in part on the first set of one or more directional beams failing to include the entirety of the second set of one or more directional beams.
Aspect 17: The method of aspect 15, wherein the first set of one or more directional beams includes a subset of the second set of one or more directional beams, and the wireless repeater sets the forwarding functionality of the wireless repeater to the ON state with respect to the subset of the second set of one or more directional beams and sets the forwarding functionality of the wireless repeater to the OFF state with respect to a remainder of the second set of one or more directional beams.
Aspect 18: The method of any of aspects 1 through 17, further comprising: transmitting, to the network entity via the MT functionality of the wireless repeater, an indication of a decision at the wireless repeater to set the forwarding functionality of the wireless repeater to the ON state or the OFF state.
Aspect 19: The method of aspect 18, further comprising: transmitting, to the network entity via the MT functionality of the wireless repeater, a request for confirmation by the network entity of the decision at the wireless repeater to set the forwarding functionality of the wireless repeater to the ON state or the OFF state.
Aspect 20: The method of any of aspects 1 through 19, further comprising: transmitting, to the network entity via the MT functionality of the wireless repeater, a request for second control signaling indicating at least one of an updated first configuration for directional communications between the wireless repeater and the UE or an updated second configuration for directional communications between the wireless repeater and the network entity, or both.
Aspect 21: The method of any of aspects 1 through 20, further comprising: receiving, from the network entity at the MT functionality of the wireless repeater, second control signaling indicating at least one of an updated first configuration for directional communications between the wireless repeater and the UE or an updated second configuration for directional communications between the wireless repeater and the network entity, or both, based at least in part on the BFR procedure; setting the forwarding functionality of the wireless repeater to the ON state in accordance with receiving the second control signaling; and relaying, via the forwarding functionality of the wireless repeater, second uplink communication from the UE to the network entity or second downlink communication from the network entity to the UE, or both, in accordance with at least one of the updated first configuration for directional communications and the updated second configuration for directional communications.
Aspect 22: The method of any of aspects 1 through 21, further comprising: transmitting, to the network entity via the MT functionality of the wireless repeater, an indication of a capability of the wireless repeater associated with setting the forwarding functionality of the wireless repeater to the ON state or the OFF state based at least in part on the BFR procedure.
Aspect 23: The method of aspect 22, wherein the capability is indicative of a specific one or more mechanisms, from a set of mechanisms, according to which the wireless repeater is able to determine whether to set the forwarding functionality of the wireless repeater to the ON state or the OFF state based at least in part on the BFR procedure.
Aspect 24: The method of any of aspects 1 through 23, wherein setting the forwarding functionality of the wireless repeater to the ON state is associated with a continued use of at least one of the first configuration for directional communications between the wireless repeater and the UE or the second configuration for directional communications between the wireless repeater and the network entity after the BFR procedure, the wireless repeater continues to relay communications between the UE and the network entity if the forwarding functionality of the wireless repeater is set to the ON state.
Aspect 25: The method of any of aspects 1 through 24, wherein setting the forwarding functionality of the wireless repeater to the OFF state is associated with a waiting for second control signaling indicating at least one of an updated first configuration for directional communications between the wireless repeater and the UE or an updated second configuration for directional communications between the wireless repeater and the network entity, or both, the wireless repeater refrains from relaying communications between the UE and the network entity if the forwarding functionality of the wireless repeater is set to the OFF state.
Aspect 26: A method for wireless communication at a network entity, comprising: outputting, to an MT functionality of a wireless repeater for use at a forwarding functionality of the wireless repeater, control signaling indicating at least one of a first configuration for directional communications between the wireless repeater and a UE or a second configuration for directional communications between the wireless repeater and the network entity; participating in uplink communication from the UE to the network entity via the forwarding functionality of the wireless repeater or downlink communication from the network entity to the UE via the forwarding functionality of the wireless repeater, or both; performing a BFR procedure in accordance with a beam failure associated with the MT functionality of the wireless repeater; and communicating with the wireless repeater in accordance with a setting of the forwarding functionality of the wireless repeater to an ON state or an OFF state based at least in part on the BFR procedure.
Aspect 27: The method of aspect 26, further comprising: starting a timer in accordance with performing the BFR procedure; and expecting the forwarding functionality of the wireless repeater to be set to the OFF state until: the network entity transmits second control signaling indicating at least one of an updated first configuration for directional communications between the wireless repeater and the UE or an updated second configuration for directional communications between the wireless repeater and the network entity, or both; or an expiration of the timer.
Aspect 28: The method of aspect 27, further comprising: obtaining, from the MT functionality of the wireless repeater, a recovery indication in accordance with the BFR procedure; and outputting, to the MT functionality of the wireless repeater, a response to the recovery indication in accordance with the BFR procedure, wherein the network entity starts the timer based at least in part on transmitting the response to the recovery indication.
Aspect 29: The method of aspect 27, further comprising: obtaining, from the MT functionality of the wireless repeater, a recovery indication in accordance with the BFR procedure, wherein the network entity starts the timer based at least in part on receiving the recovery indication.
Aspect 30: The method of any of aspects 26 through 29, further comprising: outputting, to the MT functionality of the wireless repeater, an indication of whether the wireless repeater is to set the forwarding functionality of the wireless repeater to the ON state or the OFF state after the BFR procedure.
Aspect 31: The method of aspect 30, wherein transmitting the indication to the wireless repeater further comprises: outputting the indication via a response to a recovery indication associated with the BFR procedure.
Aspect 32: The method of aspect 30, wherein transmitting the indication to the wireless repeater further comprises: outputting the indication via separate signaling after a response to a recovery indication associated with the BFR procedure.
Aspect 33: The method of any of aspects 30 through 32, wherein the indication is to set the forwarding functionality of the wireless repeater to the OFF state for a time period after the BFR procedure, and the network entity selectively transmits second control signaling indicating at least one of an updated first configuration for directional communications between the wireless repeater and the UE or an updated second configuration for directional communications between the wireless repeater and the network entity, or both, during the time period.
Aspect 34: The method of any of aspects 26 through 33, further comprising: obtaining, from the MT functionality of the wireless repeater, an indication of a decision at the wireless repeater to set the forwarding functionality of the wireless repeater to the ON state or the OFF state.
Aspect 35: The method of aspect 34, further comprising: obtaining, from the MT functionality of the wireless repeater, a request for confirmation by the network entity of the decision at the wireless repeater to set the forwarding functionality of the wireless repeater to the ON state or the OFF state.
Aspect 36: The method of any of aspects 26 through 35, further comprising: obtaining, from the MT functionality of the wireless repeater, a request for second control signaling indicating at least one of an updated first configuration for directional communications between the wireless repeater and the UE or an updated second configuration for directional communications between the wireless repeater and the network entity, or both.
Aspect 37: The method of any of aspects 26 through 36, further comprising: obtaining, from the MT functionality of the wireless repeater, an indication of a capability of the wireless repeater associated with setting the forwarding functionality of the wireless repeater to the ON state or the OFF state based at least in part on the BFR procedure.
Aspect 38: The method of any of aspects 26 through 37, wherein the setting of the forwarding functionality of the wireless repeater to the ON state is associated with a continued use of at least one of the first configuration for directional communications between the wireless repeater and the UE or the second configuration for directional communications between the wireless repeater and the network entity after the BFR procedure, the wireless repeater continues to relay communications between the UE and the network entity if the forwarding functionality of the wireless repeater is set to the ON state.
Aspect 39: The method of any of aspects 26 through 38, wherein the setting of the forwarding functionality of the wireless repeater to the OFF state is associated with a selective transmission of second control signaling indicating at least one of an updated first configuration for directional communications between the wireless repeater and the UE or an updated second configuration for directional communications between the wireless repeater and the network entity, or both, the wireless repeater refrains from relaying communications between the UE and the network entity if the forwarding functionality of the wireless repeater is set to the OFF state.
Aspect 40: An apparatus for wireless communication at a wireless repeater, comprising one or more processors; one or more memories coupled with the one or more processors; and instructions stored in the one or more memories and executable by the one or more processors to cause the apparatus to perform a method of any of aspects 1 through 25.
Aspect 41: An apparatus for wireless communication at a wireless repeater, comprising at least one means for performing a method of any of aspects 1 through 25.
Aspect 42: A non-transitory computer-readable medium storing code for wireless communication at a wireless repeater, the code comprising instructions executable by one or more processors to perform a method of any of aspects 1 through 25.
Aspect 43: An apparatus for wireless communication at a network entity, comprising one or more processors; one or more memories coupled with the one or more processors; and instructions stored in the one or more memories and executable by the one or more processors to cause the apparatus to perform a method of any of aspects 26 through 39.
Aspect 44: An apparatus for wireless communication at a network entity, comprising at least one means for performing a method of any of aspects 26 through 39.
Aspect 45: A non-transitory computer-readable medium storing code for wireless communication at a network entity, the code comprising instructions executable by one or more processors to perform a method of any of aspects 26 through 39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless repeater, comprising:
one or more processors;
one or more memories coupled with the one or more processors; and
instructions stored in the one or more memories and executable by the one or more processors to cause the apparatus to:
receive, from a network entity at a mobile termination functionality of the wireless repeater, control signaling indicating at least one of a first configuration for directional communications between the wireless repeater and a user equipment (UE) or a second configuration for directional communications between the wireless repeater and the network entity;
relay, via a forwarding functionality of the wireless repeater, uplink communication from the UE to the network entity or downlink communication from the network entity to the UE, or both, in accordance with at least one of the first configuration for directional communications or the second configuration for directional communications;
perform, at the mobile termination functionality of the wireless repeater, a beam failure recovery procedure in accordance with a beam failure associated with the mobile termination functionality of the wireless repeater; and
set the forwarding functionality of the wireless repeater to an ON state or an OFF state based at least in part on the beam failure recovery procedure.

2. The apparatus of claim 1, wherein the instructions to set the forwarding functionality of the wireless repeater to the ON state or the OFF state are further executable by the one or more processors to cause the apparatus to:
set the forwarding functionality of the wireless repeater to the OFF state until second control signaling indicates at least one of an updated first configuration for directional communications between the wireless repeater and the UE or an updated second configuration for directional communications between the wireless repeater and the network entity, or both.

3. The apparatus of claim 2, wherein, to set the forwarding functionality, the instructions are further executable by the one or more processors to cause the apparatus to:
determine the updated first configuration and the updated second configuration based at least in part on a successful beam failure recovery procedure.

4. The apparatus of claim 1, wherein the instructions are further executable by the one or more processors to cause the apparatus to:
receive, from the network entity at the mobile termination functionality of the wireless repeater, an indication of whether the wireless repeater is to set the forwarding functionality of the wireless repeater to the ON state or the OFF state after the beam failure recovery procedure.

5. The apparatus of claim 4, wherein the instructions to receive the indication from the network entity are further executable by the one or more processors to cause the apparatus to:
receive the indication via a response to a recovery indication associated with the beam failure recovery procedure.

6. The apparatus of claim 4, wherein the instructions to receive the indication from the network entity are further executable by the one or more processors to cause the apparatus to:
receive the indication via separate signaling after a response to a recovery indication associated with the beam failure recovery procedure.

7. The apparatus of claim 4, wherein the indication is to set the forwarding functionality of the wireless repeater to the OFF state for a time period after the beam failure recovery procedure, and wherein the wireless repeater monitors for second control signaling indicating at least one of an updated first configuration for directional communications between the wireless repeater and the UE or an updated second configuration for directional communications between the wireless repeater and the network entity, or both, for a duration of the time period.

8. The apparatus of claim 1, wherein the instructions are further executable by the one or more processors to cause the apparatus to:
transmit, to the network entity via the mobile termination functionality of the wireless repeater, an indication of a decision at the wireless repeater to set the forwarding functionality of the wireless repeater to the ON state or the OFF state.

9. The apparatus of claim 1, wherein the instructions are further executable by the one or more processors to cause the apparatus to:
transmit, to the network entity via the mobile termination functionality of the wireless repeater, a request for second control signaling indicating at least one of an updated first configuration for directional communications between the wireless repeater and the UE or an updated second configuration for directional communications between the wireless repeater and the network entity, or both.

10. The apparatus of claim 1, wherein the instructions are further executable by the one or more processors to cause the apparatus to:
receive, from the network entity at the mobile termination functionality of the wireless repeater, second control signaling indicating at least one of an updated first configuration for directional communications between the wireless repeater and the UE or an updated second configuration for directional communications between the wireless repeater and the network entity, or both, based at least in part on the beam failure recovery procedure;
set the forwarding functionality of the wireless repeater to the ON state in accordance with receiving the second control signaling; and
relay, via the forwarding functionality of the wireless repeater, second uplink communication from the UE to the network entity or second downlink communication from the network entity to the UE, or both, in accordance with at least one of the updated first configuration for directional communications and the updated second configuration for directional communications.

11. The apparatus of claim 1, wherein setting the forwarding functionality of the wireless repeater to the OFF state is associated with a waiting for second control signaling indicating at least one of an updated first configuration for directional communications between the wireless repeater and the UE or an updated second configuration for directional communications between the wireless repeater and the network entity, or both, and wherein the wireless repeater refrains from relaying communications between the UE and the network entity if the forwarding functionality of the wireless repeater is set to the OFF state.

12. An apparatus for wireless communication at a network entity, comprising:
one or more processors;
one or more memories coupled with the one or more processors; and
instructions stored in the one or more memories and executable by the one or more processors to cause the apparatus to:
output, to a mobile termination functionality of a wireless repeater for use at a forwarding functionality of the wireless repeater, control signaling indicating at least one of a first configuration for directional communications between the wireless repeater and a user equipment (UE) or a second configuration for directional communications between the wireless repeater and the network entity;
participate in uplink communication from the UE to the network entity via the forwarding functionality of the wireless repeater or downlink communication from the network entity to the UE via the forwarding functionality of the wireless repeater, or both;
perform a beam failure recovery procedure in accordance with a beam failure associated with the mobile termination functionality of the wireless repeater; and
communicate with the wireless repeater in accordance with a setting of the forwarding functionality of the wireless repeater to an ON state or an OFF state based at least in part on the beam failure recovery procedure.

13. The apparatus of claim 12, wherein, to communicate with the wireless repeater, the instructions are further executable by the one or more processors to cause the apparatus to:
determine an updated first configuration or an updated second configuration based at least in part on a successful beam failure recovery procedure.

14. The apparatus of claim 12, wherein the instructions are further executable by the one or more processors to cause the apparatus to:
output, to the mobile termination functionality of the wireless repeater, an indication of whether the wireless repeater be to set the forwarding functionality of the wireless repeater to the ON state or the OFF state after the beam failure recovery procedure.

15. The apparatus of claim 14, wherein the instructions to transmit the indication to the wireless repeater are further executable by the one or more processors to cause the apparatus to:
output the indication via a response to a recovery indication associated with the beam failure recovery procedure.

16. The apparatus of claim 14, wherein the instructions to transmit the indication to the wireless repeater are further executable by the one or more processors to cause the apparatus to:
output the indication via separate signaling after a response to a recovery indication associated with the beam failure recovery procedure.

17. The apparatus of claim 14, wherein the indication is to set the forwarding functionality of the wireless repeater to the OFF state for a time period after the beam failure recovery procedure, and wherein the network entity selectively outputs second control signaling indicating at least one of an updated first configuration for directional communications between the wireless repeater and the UE or an updated second configuration for directional communications between the wireless repeater and the network entity, or both, during the time period.

18. The apparatus of claim 12, wherein the instructions are further executable by the one or more processors to cause the apparatus to:
obtain, from the mobile termination functionality of the wireless repeater, an indication of a decision at the wireless repeater to set the forwarding functionality of the wireless repeater to the ON state or the OFF state.

19. The apparatus of claim 12, wherein the instructions are further executable by the one or more processors to cause the apparatus to:
obtain, from the mobile termination functionality of the wireless repeater, a request for second control signaling indicating at least one of an updated first configuration for directional communications between the wireless repeater and the UE or an updated second configuration for directional communications between the wireless repeater and the network entity, or both.

20. The apparatus of claim 12, wherein the setting of the forwarding functionality of the wireless repeater to the OFF state is associated with a selective transmission of second control signaling indicating at least one of an updated first configuration for directional communications between the wireless repeater and the UE or an updated second configuration for directional communications between the wireless repeater and the network entity, or both, and wherein the wireless repeater refrains from relaying communications between the UE and the network entity if the forwarding functionality of the wireless repeater is set to the OFF state.

21. A method for wireless communication at a wireless repeater, comprising:
receiving, from a network entity at a mobile termination functionality of the wireless repeater, control signaling indicating at least one of a first configuration for directional communications between the wireless repeater and a user equipment (UE) or a second configuration for directional communications between the wireless repeater and the network entity;
relaying, via a forwarding functionality of the wireless repeater, uplink communication from the UE to the network entity or downlink communication from the network entity to the UE, or both, in accordance with at least one of the first configuration for directional communications or the second configuration for directional communications;
performing, at the mobile termination functionality of the wireless repeater, a beam failure recovery procedure in accordance with a beam failure associated with the mobile termination functionality of the wireless repeater; and
setting the forwarding functionality of the wireless repeater to an ON state or an OFF state based at least in part on the beam failure recovery procedure.

22. The method of claim 21, wherein setting the forwarding functionality of the wireless repeater to the ON state or the OFF state further comprises:
setting the forwarding functionality of the wireless repeater to the OFF state until second control signaling indicates at least one of an updated first configuration for directional communications between the wireless repeater and the UE or an updated second configuration for directional communications between the wireless repeater and the network entity, or both.

23. The method of claim 21, further comprising:
determining an updated first configuration or an updated second configuration based at least in part on a successful beam failure recovery procedure.

24. The method of claim 21, further comprising:
receiving, from the network entity at the mobile termination functionality of the wireless repeater, an indication of whether the wireless repeater is to set the forwarding functionality of the wireless repeater to the ON state or the OFF state after the beam failure recovery procedure.

25. The method of claim 21, wherein the indication is to set the forwarding functionality of the wireless repeater to the OFF state for a time period after the beam failure recovery procedure, and wherein the wireless repeater monitors for second control signaling indicating at least one of an updated first configuration for directional communications between the wireless repeater and the UE or an updated second configuration for directional communications between the wireless repeater and the network entity, or both, for a duration of the time period.

26. The method of claim 21, further comprising:
transmitting, to the network entity via the mobile termination functionality of the wireless repeater, an indication of a decision at the wireless repeater to set the forwarding functionality of the wireless repeater to the ON state or the OFF state.

27. A method for wireless communication at a network entity, comprising:
outputting, to a mobile termination functionality of a wireless repeater for use at a forwarding functionality of the wireless repeater, control signaling indicating at least one of a first configuration for directional communications between the wireless repeater and a user equipment (UE) or a second configuration for directional communications between the wireless repeater and the network entity;
participating in uplink communication from the UE to the network entity via the forwarding functionality of the wireless repeater or downlink communication from the network entity to the UE via the forwarding functionality of the wireless repeater, or both;
performing a beam failure recovery procedure in accordance with a beam failure associated with the mobile termination functionality of the wireless repeater; and
communicating with the wireless repeater in accordance with a setting of the forwarding functionality of the wireless repeater to an ON state or an OFF state based at least in part on the beam failure recovery procedure.

28. The method of claim 27, further comprising:
determining an updated first configuration or an updated second configuration based at least in part on a successful beam failure recovery procedure.

29. The method of claim 27, further comprising:
outputting, to the mobile termination functionality of the wireless repeater, an indication of whether the wireless repeater is to set the forwarding functionality of the wireless repeater to the ON state or the OFF state after the beam failure recovery procedure.

30. The method of claim 27, further comprising:
obtaining, from the mobile termination functionality of the wireless repeater, an indication of a capability of the wireless repeater associated with setting the forwarding functionality of the wireless repeater to the ON state or the OFF state based at least in part on the beam failure recovery procedure.
